(19) United States
(12) Patent Application Publication
(10) Pub. No.: US 2013/0183906 A1
(43) Pub. Date: Jul. 18, 2013

(54) ENHANCED DISTRIBUTED SYNCHRONIZATION FOR WIRELESS COMMUNICATIONS

(71) Applicants: Saurabh Tavildar, Jersey City, NJ (US); Thomas J. Richardson, South Orange, NJ (US); Simone Merlin, San Diego, CA (US); Santosh Paul Abraham, San Diego, CA (US); Zhibin Wu, Bedminster, NJ (US); Junyi Li, Chester, NJ (US); Nilesh N. Khude, Bridgewater, NJ (US); Hemanth Sampath, San Diego, CA (US)

(72) Inventors: Saurabh Tavildar, Jersey City, NJ (US); Thomas J. Richardson, South Orange, NJ (US); Simone Merlin, San Diego, CA (US); Santosh Paul Abraham, San Diego, CA (US); Zhibin Wu, Bedminster, NJ (US); Junyi Li, Chester, NJ (US); Nilesh N. Khude, Bridgewater, NJ (US); Hemanth Sampath, San Diego, CA (US)

(73) Assignee: QUALCOMM Incorporated, San Diego, CA (US)

(21) Appl. No.: 13/349,253

(22) Filed: Jan. 12, 2012

(51) Int. Cl. H04W 24/02; H04W 56/00

(52) U.S. Cl. 455/67.11

(57) ABSTRACT

Methods and apparatus are described which increase the probability and/or frequency that devices with comparatively faster clocks in a network than other devices in the network will transmit beacon signals are described. As a result, devices with faster clocks will tend to drive system synchronization to convergence faster than if all devices transmitted beacons at the same rate, thus facilitating more reliable maintenance of system synchronization since the devices with faster clocks will tend to transmit more frequently.

### FIELD

Various embodiments are directed to wireless communication device synchronization in a network and more specifically, to methods and apparatus for efficiently performing distributed synchronization, e.g., in an ad-hoc network.

### BACKGROUND

Wireless devices, e.g., portable devices, often use relatively inexpensive, and thus often somewhat inaccurate, clocks to maintain their understanding of time. As a result of differences between crystal oscillators in different devices, the internal clocks of different devices may drift causing devices in a network to lose synchronization over time unless measures are taken to maintain synchronization between the different devices.

In at least some systems devices transmit beacon signals including information, in the form of a time stamp, indicating the transmitting device's understanding of the current time. Devices in the network receiving the time indicated in the beacon signal can compare the indicated time to the time indicated by their internal clock.

In some systems, devices which receive a beacon signal indicating a time which is ahead of the time indicated by the device's internal clock will change the device's internal time to match that of the time indicated in the beacon signal. From multiple beacon signals received from the same device over time, it is possible to obtain an understanding of how fast the transmitting device's clock is, relative the internal clock of the device receiving the beacon signals.

In some systems devices adjust their clocks if the time indicated in a beacon signal is ahead of the internal time at which the device detects receipt of the beacon signal, but not if the time indicated in the beacon signal is behind the time indicated by the device's internal clock. In such systems beacon signals from devices having relatively slow clocks will result in fewer timing adjustments being made than beacon signals from devices having faster clocks. Accordingly, the beacon signals transmitted by the devices having slower clocks are less likely than the beacon signals from the devices having faster clocks to facilitate achieving and/or maintaining timing synchronization.

Generally in systems which use beacon signals, the relative clock rates of different devices are not taken into consideration when determining if or how frequently a device should transmit beacon signals. It should be appreciated that it would be desirable if methods and/or apparatus could be developed which would increase the probability and/or frequency of devices with faster clocks transmitting beacon signals including timing information used for synchronization purposes and/or decrease the probability and/or frequency of devices with comparatively slow clocks transmitting beacon signals.

### SUMMARY

Methods and apparatus which increase the probability and/or frequency that devices with comparatively faster clocks in a network will transmit beacon signals are described. As a result, devices with faster clocks will tend to drive system synchronization to faster convergence and facilitate more reliable maintenance of system synchronization since the devices with faster clocks will tend to transmit synchronization signals, e.g., beacon signals, more frequently than other devices.

In various embodiments, a wireless communications device selects an initial backoff time value for a beacon slot to control the likelihood that the wireless communications device will transmit a beacon signal during the beacon slot. In some embodiments, the exemplary method increases the likelihood that a wireless communications device which transmitted a beacon signal in a beacon slot and did not adjust its clock timing based on a received beacon signal from another device during the beacon slot will transmit a beacon signal during the next successive beacon slot.

The coverage range of the devices may be, and in some embodiments is, taken into consideration in determining whether or not a device should transmit a beacon signal in a beacon slot. If a device receives a strong beacon signal the received beacon signal is likely to have a similar coverage range to that which may be achieved by device transmission. In some embodiments, the intended beacon transmission is cancelled based on the characteristics of the received beacon signal satisfying certain criteria. In some embodiments, the criteria used for cancellation of an intended beacon signal include a time indication criteria and a received power level criteria. In some embodiments cancellation criteria include a requirement that the time indicated in the received beacon signal be greater than the time indicated by the clock of the communications device which received the beacon signal and that the power level of the received beacon signal exceed a threshold used to determine that the device which transmitted the received beacon is very close to the device which received the beacon. If the cancellation criteria are satisfied a beacon transmission is cancelled, and the beacon signal is not sent. Cancellation differs from a simple pause of counting down a backoff count which may occur due to the results of a carrier sensing operation but does not result in cancellation of the beacon transmission.

In some embodiments, a wireless communications device reduces a current backoff time value in response to a detected beacon signal satisfying certain criteria, other than a sensed carrier being unoccupied for a period of time, to increase the likelihood that the wireless communications device will transmit its intended beacon signal during the current beacon slot. In some embodiments, the criteria used for reducing a current backoff time value in response to a detected beacon signal include a time indication critera, e.g., the time indicated in the received beacon signal is less than the time indicated by the clock of the communications device which received the beacon signal.

An exemplary method of operating a communications device, in accordance with some embodiments, comprises: determining a backoff time used in controlling transmission of a first beacon signal in a first beacon slot; monitoring to detect receipt of a beacon signal during said backoff time; and in response to said monitoring detecting receipt of a beacon signal performing one of: altering said determined backoff time or canceling transmission of the beacon signal. An exemplary communications device, in accordance with some embodiments, comprises: at least one processor configured to: determine a backoff time used in controlling transmission of a first beacon signal in a first beacon slot; monitor to detect receipt of a beacon signal during said backoff time; and perform one of: altering said determined backoff time or canceling transmission of the beacon signal, in response to said monitoring detecting receipt of a beacon signal. The exemplary communications device further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary communications system in accordance with an exemplary embodiment.

FIG. 2A is a first part of a flowchart of an exemplary method of operating a communications device in accordance with various exemplary embodiments.

FIG. 2B is a second part of a flowchart of an exemplary method of operating a communications device in accordance with various exemplary embodiments.

FIG. 2C is a third part of a flowchart of an exemplary method of operating a communications device in accordance with various exemplary embodiments.

FIG. 3 is a drawing of an exemplary communications device, e.g., a peer to peer wireless communications device, in accordance with an exemplary embodiment.

FIG. 4A is a first part of an assembly of modules which can, and in some embodiments is, used in the exemplary wireless communications device illustrated in FIG. 3.

FIG. 4B is a second part of an assembly of modules which can, and in some embodiments is, used in the exemplary wireless communications device illustrated in FIG. 3.

FIG. 4C is a third part of an assembly of modules which can, and in some embodiments is, used in the exemplary wireless communications device illustrated in FIG. 3.

FIG. 5 illustrates an example of exemplary peer to peer wireless terminal determining a backoff time, used to control transmission of a beacon signal, based on information corresponding to received beacon signals from a prior beacon slot in accordance with an exemplary embodiment.

FIG. 6 illustrates another example of an exemplary peer to peer wireless terminal determining a backoff time, used to control transmission of a beacon signal, based on information corresponding to received beacon signals from a prior beacon slot in accordance with an exemplary embodiment.

FIG. 7 illustrates an example of an exemplary peer to peer wireless terminal determining a backoff time, used to control transmission of a beacon signal, based on whether or not the wireless terminal transmitted a beacon in an immediately preceding beacon slot in accordance with an exemplary embodiment.

FIG. 8 illustrates another example of an exemplary peer to peer wireless terminal determining a backoff time, used to control transmission of a beacon signal, based on whether or not the wireless terminal transmitted a beacon in an immediately preceding beacon slot in accordance with an exemplary embodiment.

FIG. 9 illustrates an exemplary peer to peer wireless terminal reducing its current value of its backoff time value in response to detecting a beacon signal from another wireless terminal with characteristics that satisfies particular criteria in accordance with an exemplary embodiment.

FIG. 10 illustrates an exemplary peer to peer wireless terminal cancelling an intended beacon signal transmission in response to detecting a beacon signal from another wireless terminal with characteristics that satisfies particular criteria in accordance with an exemplary embodiment.

FIG. 11 illustrates an exemplary peer to peer wireless terminal transmitting an intended beacon signal transmission in response to detecting that its backoff timer has expired within the current beacon slot in accordance with an exemplary embodiment.

FIG. 12 illustrates an exemplary peer to peer wireless terminal cancelling an intended beacon signal transmission in response to detecting that the current beacon slot has expired in accordance with an exemplary embodiment.

### DETAILED DESCRIPTION

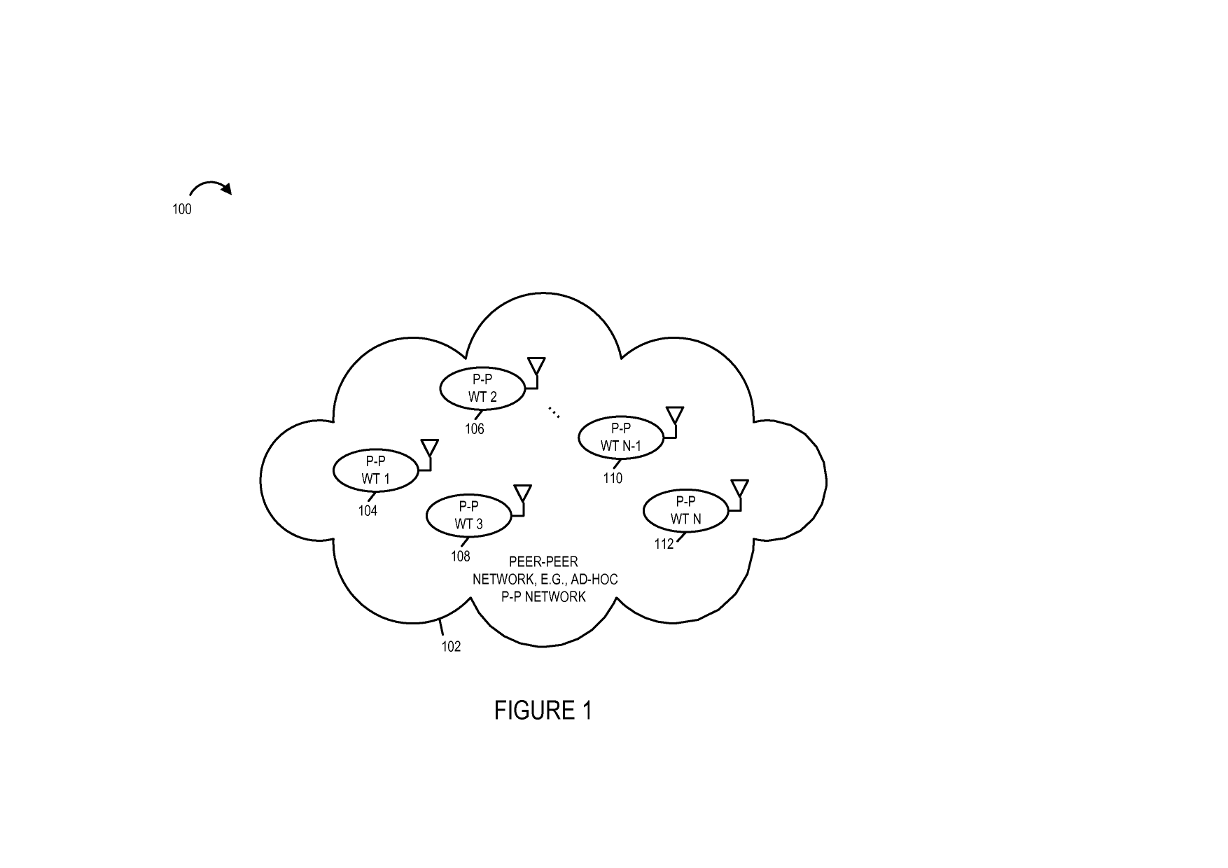

FIG. 1 is a drawing of an exemplary communications system 100 in accordance with an exemplary embodiment. Exemplary communications system 100 includes a peer to peer network 102, e.g., an ad-hoc peer to peer network. Peer to peer network includes a plurality of peer to peer wireless terminals (peer to peer wireless terminal 1 104, peer to peer wireless terminal 2 106, peer to peer wireless terminal 3 108, . . . , peer to peer wireless terminal N−1 110, peer to peer wireless terminal N 112.

At least some of the peer to peer wireless terminals (104, 106, 108, . . . , 110, 112) are mobile devices that implement peer to peer communications, e.g., direct device to device communications. The peer to peer wireless terminals may move throughout system 100 and form multiple local peer to peer networks which may be disconnected from one another and/or overlap with one another.

In various embodiments, timing synchronization of the network 102 is performed in a decentralized manner. Wireless communications devices (104, 106, 108, . . . , 110, 112) transmit beacon signals including time stamps communicating the transmitting device's notion of time. In some embodiments time stamps are in microseconds. The network tends to synchronize to the device with the fastest clock in the network. A device intending to transmit a beacon signal in a beacon slot determines a backoff time value, used for controlling transmission of the intended beacon signal. The determined backoff time value is, in some embodiments, an initial setting for a backoff timer which counts down during the beacon slot under certain predetermined conditions, e.g., the device is not sensing a received signal above a first power threshold or a decodable signal. The determined backoff time, in some embodiments, is a function of statistical information corresponding to previously received beacon signals and/or whether or not the device transmitted a beacon signal in a preceding beacon slot and/or whether or not the wireless communications device adjusted its clock in the prior beacon slot based on received beacon signals from other wireless communications devices.

In accordance with a feature of various embodiments, the current backoff time is altered, e.g., reduced, in a current beacon slot in response to a received beacon signal from another device meeting certain predetermined criteria. Decreasing the backoff time increases the likelihood that the intended beacon will be transmitted during the beacon slot. In accordance with a feature of various embodiments, the intended beacon transmission is cancelled for the current beacon slot in response to a received beacon signal meeting certain predetermined criteria.

A wireless communications device, e.g., peer to peer wireless terminal 104, monitors to detect beacon signals from other devices during its backoff time, e.g., before its backoff timer has expired. The wireless communications device performs one of altering the determined backoff time or canceling transmission of the intended beacon in response to a detected beacon signal having certain characteristics. For example, the wireless communications device reduces the backoff time value in response to determining that the time indicated in the received beacon signal is less than the time indicated by the clock of the communications device receiving the beacon signal. In this example, the wireless communications device has determined that it has a faster clock than the device which transmitted the beacon signal and wireless communications device would like to increase its likelihood that it transmits a beacon signal in the current beacon slot. As another example, the wireless communications device cancels the intended beacon transmission if the power of the received beacon exceeds a second power level threshold and the time indicated in the received beacon signal is greater than the time indicated by the clock of the transmitting device. In this example, a very strong received beacon signal from a device with a faster clock has been detected. The very strong received beacon signal indicates the device which transmitted the beacon signal is closely located to the device which received the beacon signal, and since it is desirable to synchronize the network to the faster clock there is no point in transmitting the intended beacon signal since the receiving signal has updated its timing to match the faster clock and the transmitted beacon would be redundant resulting in a waste of battery power and air link resources.

In various embodiments, the network 102 synchronizes with respect to the clock of wireless communications device having the fastest clock. In one aspect of some embodiments, an intended beacon signal which would be substantially redundant is cancelled based on a characteristic of received beacon signal received during the time slot of the intended transmission. In another aspect of some embodiments, a likelihood of transmission of an intended beacon signal transmission during a beacon slot is increased based on a characteristic of a received beacon signal received during the beacon slot, e.g., the backoff time is reduced in response to the received beacon signal satisfying predetermined criteria.

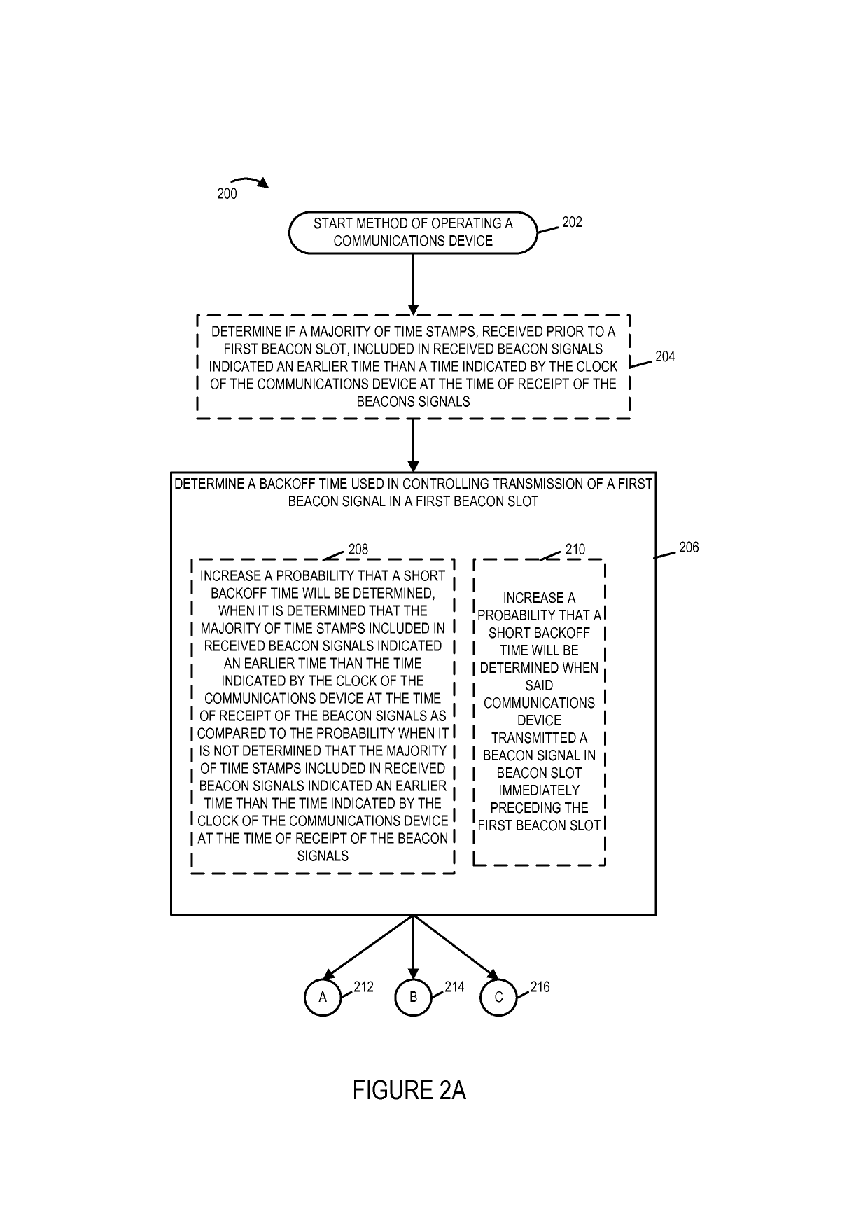

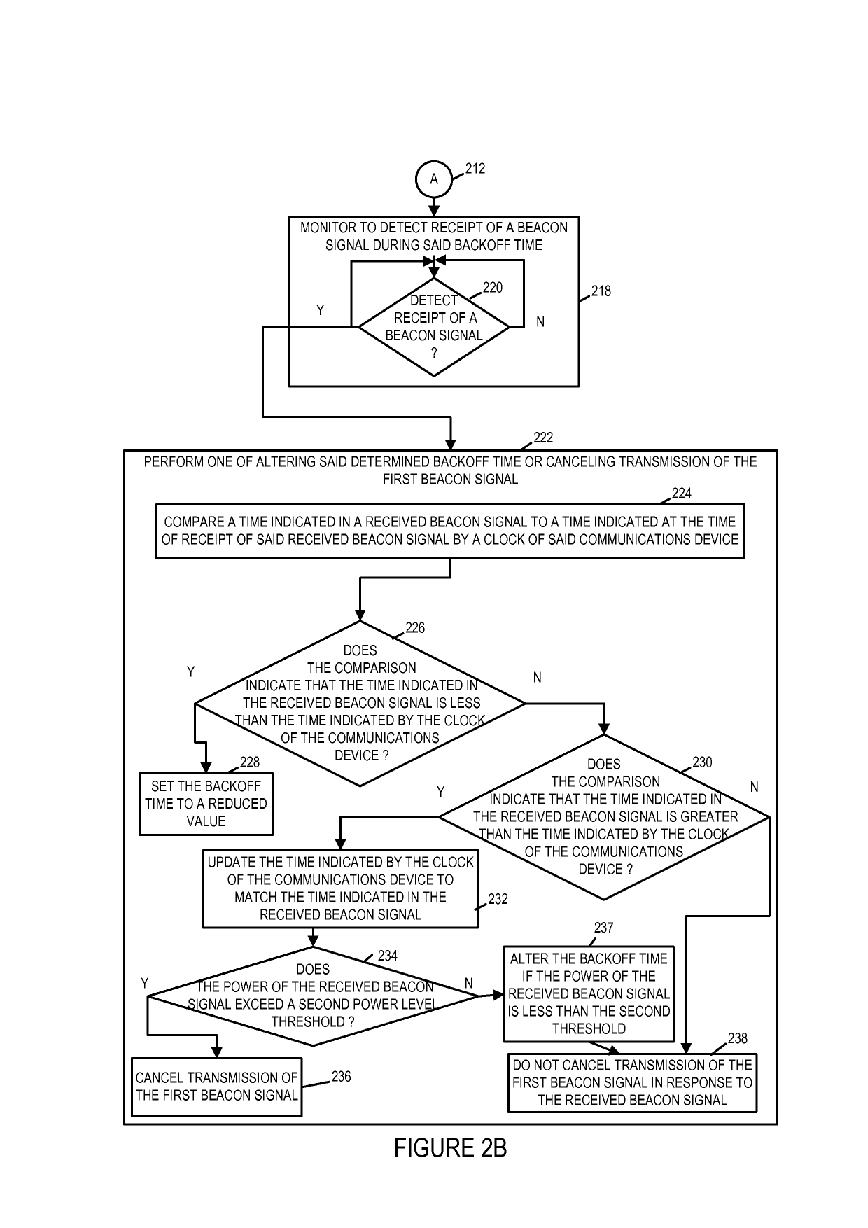

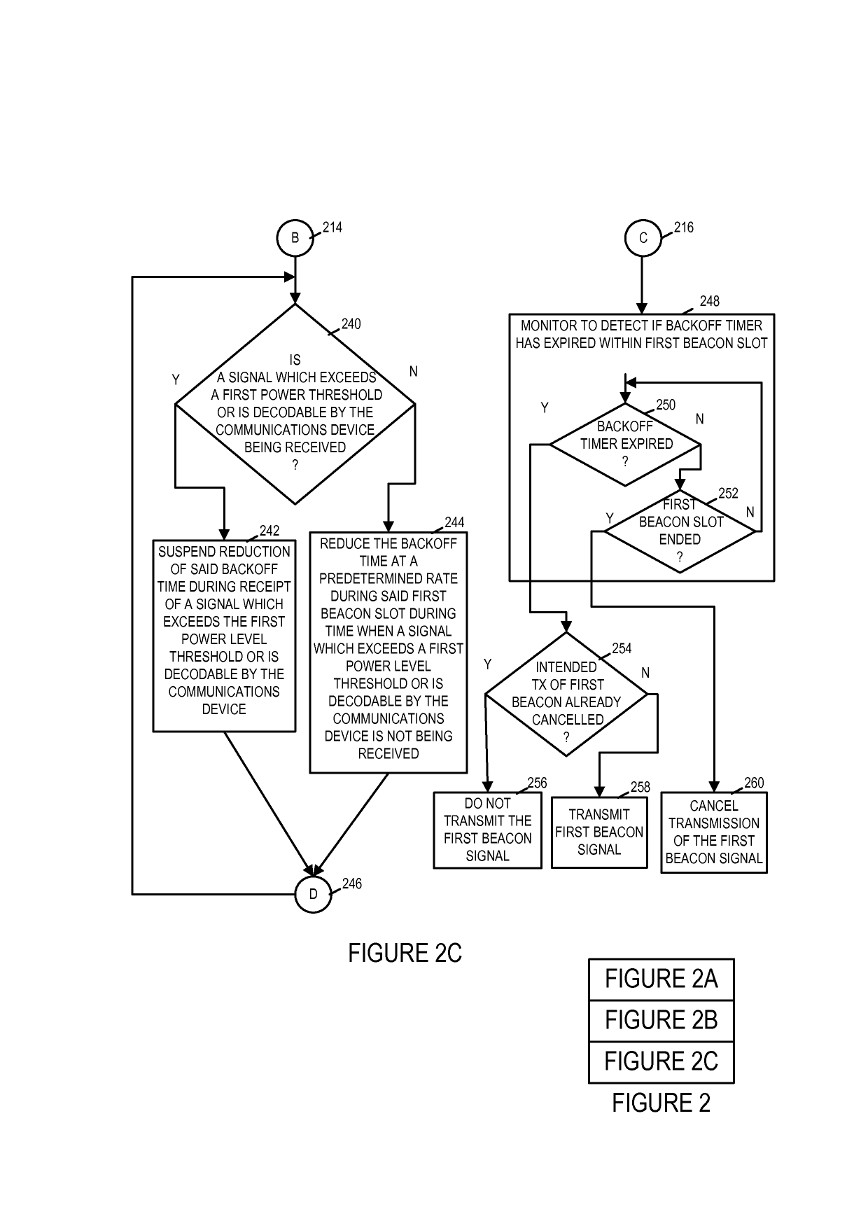

FIG. 2, comprising the combination of FIG. 2A, FIG. 2B and FIG. 2C is a flowchart 200 of an exemplary method of operating a communications device in accordance with various exemplary embodiments. Operation of the exemplary method starts in step 202, where the communications device is powered on and initialized and proceeds to step 204. In step 204, the communications device determines if a majority of time stamps, received prior to a first beacon slot, included in received beacon signals indicated an earlier time than a time indicated by the clock of the communications device at the time of receipt of the beacon signals. Operation proceeds from step 204 to step 206.

In step 206, the communications device determines a backoff time used in controlling transmission of a first beacon signal in a first beacon slot. In some embodiments, step 206 includes one or more of steps 208 and 210. In step 208 the communications device increases a probability that a short backoff time will be determined when it is determined that the majority of time stamps included in received beacon signals indicated an earlier time that the time indicated by the clock of the communications device at the time of receipt of the beacon signals as compared to the probability when it is not determined that the majority of time stamps included in received beacon signals indicated an earlier time than the time indicated by the clock of the communications device at the time of receipt of the beacon signals. In step 210 the communications device increases a probability that a short backoff time will be determined when said communications device transmitted a beacon signal in a beacon slot immediately preceding the first beacon slot. In some embodiments, the increase in probability of step 210 is further dependent upon the condition that the wireless communications device has not adjusted its timing in the beacon slot immediately preceding the first beacon slot based on received beacon signals from other devices.

Operation proceeds from step 206 via connecting nodes (A 212, B214, and C 216) to steps (218, 240, and 248), respectively. In step 218 the communications device monitors to detect receipt of a beacon signal during said backoff time. Step 218 includes step 220 in which the communications device checks if the communications device has detected receipt of a beacon signal. If the communications device has detected receipt of a beacon signal, then operation proceeds from step 220 to step 222 in response to the detected beacon signal; operation also proceeds from the output of step 220 to the input of step 220 to check if another beacon signal is detected at a later point in time. If the communications device has not detected receipt of a beacon signal, then operation proceeds from the output of step 220 to the input of step 220 to check a beacon signal is detected at a later point during the monitoring. One iteration of step 222 is performed for each detected beacon signal during the monitoring of step 218.

In step 222 the communications device performs one of altering said determined backoff time or canceling transmission of the first beacon signal in response to detecting a beacon signal with characteristics satisfying one or more predetermined criteria. Step 222 includes steps 224, 226, 228, 230, 232, 234, 236, 237 and 238. In step 224 the communications device compares a time indicated in a received beacon signal to a time indicated at the time of receipt of said beacon signal by a clock of said communications device. Operation proceeds from step 224 to step 226. In step 226, if the comparison of step 224 indicates that the time indicated in the received beacon signal is less than the time indicated by the clock of the communications device, then operation proceeds from step 226 to step 228, in which the communications device sets the backoff time to a reduced value, e.g., changes the current backoff time value to a reduced value. In some embodiments, the reduction of the backoff time value in step 228 is by an amount which is a function of the time difference between the time indicated in the received beacon and the time indicated by the clock of the communications device at the time the beacon was received. In some such embodiments, the larger the difference, the larger the reduction in the backoff time. In some embodiments, the reduction of the backoff time value in step 228 is by a predetermined amount. It should be appreciated that the changes, e.g., reductions, in the backoff time value in step 228 are performed independent of any internal clock changes made for synchronization purposes. However, if the comparison of step 224 does not indicate that the time indicated in the received beacon signal is less than the time indicated by the clock of the communications device, then operation proceeds from step 226 to step 230.

In step 230 the communications device tests if the comparison of step 230 indicates that the time indicated in the received beacon signal is greater than the time indicated by the clock of the communications device. If the comparison indicates that the time indicated in the received beacon signal is greater than the time indicated by the clock of the communications device then operation proceeds from step 230 to step 232 in which the communications device updates the time indicated by the clock of the communications device to match the time indicated in the received beacon signal. Operation proceeds from step 232 to step 234. In step 232 the communications device compares the power level of the received beacon signal to a second power level threshold. In various embodiments, the second power level threshold is greater than the first power level threshold. If the power of the received beacon signal exceeds a second power level threshold, then operation proceeds from step 234 to step 236; otherwise operation proceeds from step 234 to step 237. In step 236, the communications device cancels the transmission of the first beacon signal. Returning to step 237, in step 237 the communications device alters the backoff time, e.g., sets the backoff time to a reduced value, if the power of the received beacon signal is less than the second power level threshold. Operation proceeds from step 237 to step 238.

Returning to step 230, if the comparison of step 224 does not indicate that the time indicated in the received beacon signal is greater than the time indicated by the clock of the communications device then operation proceeds from step 230 to step 238. In step 238 the communications device is controlled to not perform a cancellation of the transmission of the first beacon signal in response to the received beacon signal.

Returning to step 240, in step 240 the communications device checks as to whether or not a signal which exceeds a first power threshold or is decodable by the communications device is being received. If the check of step 240 indicates that a signal which exceeds a first power threshold or is decodable by the communications device is being received, then operation proceeds from step 240 to step 242, in which the communications device suspends, e.g., stop for a period of time, reduction of said backoff time during receipt of a signal which exceeds the first power level or is decodable by the communications device. This suspension, e.g., stop for a period of time, is in contrast to cancellation as is performed in step 236 and step 260. However, if the check of step 240 does not indicate that a signal which exceeds a first power threshold or is decodable by the communications device is being received, then operation proceeds from step 240 to step 244, in which the communications device reduces a backoff time at a predetermined rate during said first beacon slot during time when a signal which exceeds a first power threshold or is decodable by the communications device is being received. In some embodiments, the first power threshold is a carrier sensing threshold level. Operation proceeds from step 242 or step 244 to step 240 via connecting node D 246.

Returning to step 248, in step 248 the communications device monitors to detect if the backoff timer has expired within the first beacon slot. Step 248 includes step 250 and step 252. In step 250 the communications device checks if the backoff timer has expired. If the backoff timer has expired, then the operation proceeds from step 250 to step 254. However, if the backoff timer has not expired then operation proceeds from step 250 to step 252. In step 252 the communications device checks if the first beacon slot has ended. If the first beacon slot has ended, operation proceeds from step 252 to step 260; otherwise, operation proceeds from step 252 to step 250, where the communications device again checks as to whether the backoff timer has expired. Returning to step 260, in step 260 the communications device cancels transmission of the first beacon signal. Returning to step 254, in step 254 the communications device checks as to whether or not the intended transmission of the first beacons signal has already been cancelled. If the intended transmission of the first beacon has already been cancelled, e.g., in step 236, then operation proceeds from step 254 to step 256 where the wireless communications device is controlled to refrain from transmitting the first beacon signal even though the backoff timer has expired and the first beacon slot has not yet ended. However, if the intended transmission of the first beacon signal has not been previously canceled then operation proceeds from step 254 to step 258, in which the communications device transmits the first beacon signal.

Flowchart 200 of FIG. 2 illustrates exemplary execution of a set of steps corresponding to one beacon slot. In general, the exemplary method of flowchart 200 is repeated for a plurality of beacons slots, e.g., a plurality of successive beacon slots with the first beacon slot identified in the flowchart corresponding to a different beacon slot for each iteration of the flowchart.

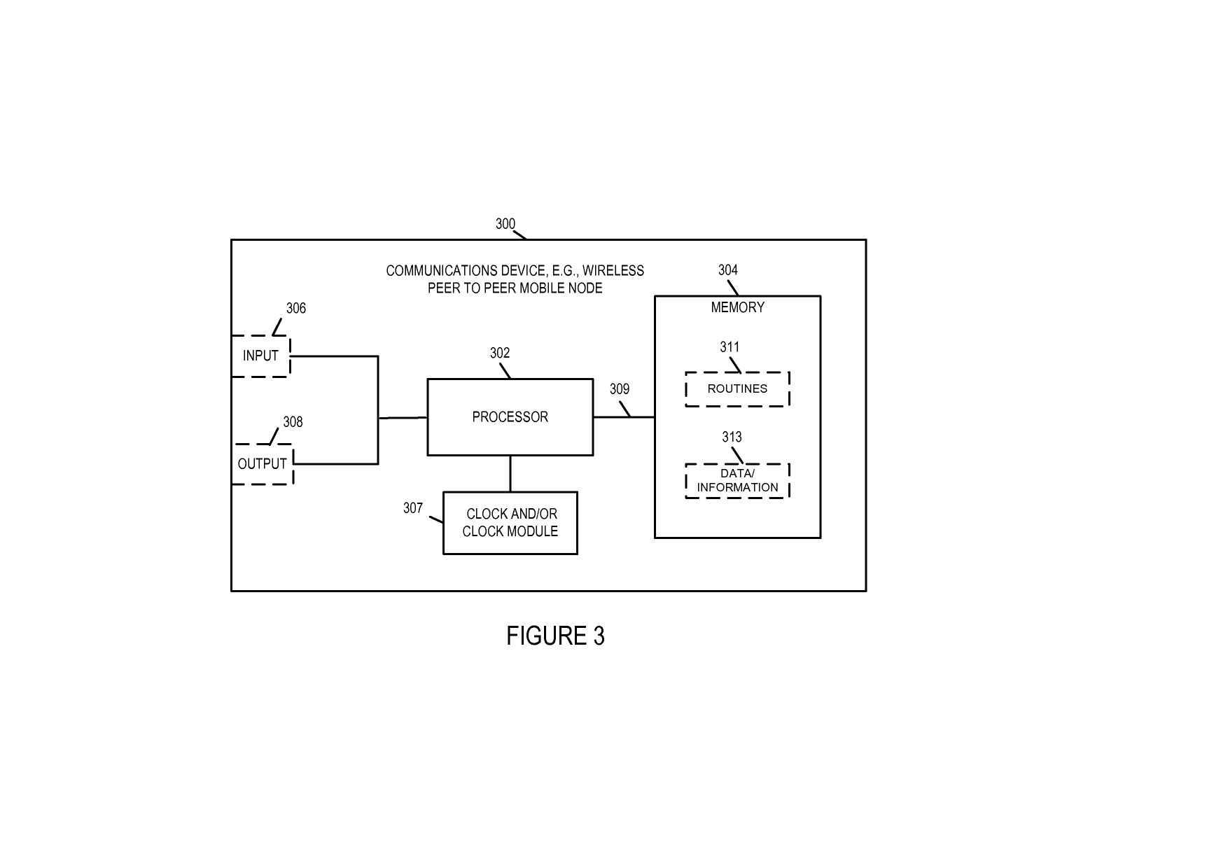

FIG. 3 is a drawing of an exemplary communications device 300, e.g., a peer to peer mobile node, in accordance with an exemplary embodiment. Exemplary communications device 300 is, e.g., one of the peer to peer wireless communications devices (peer to peer wireless terminal 1 104, peer to peer wireless terminal 2 106, peer to peer wireless terminal 3 108, . . . , peer to peer wireless terminal N−1 110, peer to peer wireless terminal N 112) system 100 of FIG. 1. Exemplary wireless communications device 300 may, and sometimes does, implement a method in accordance with flowchart 200 of FIG. 2.

Communications device 300 includes a processor 302 and memory 304 coupled together via a bus 309 over which the various elements (302, 304) may interchange data and information. Communications device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 311 and data/information 313. Communications device 300 also includes a clock and/or clock module 307 coupled to processor 302. In some embodiments, the clock and/or clock module 307 are located internal to processor 302.

In some embodiments, processor 302 is configured to: determine a backoff time used in controlling transmission of a first beacon signal in a first beacon slot; monitor to detect receipt of a beacon signal during said backoff time; and perform one of: altering said determined backoff time or canceling transmission of the beacon signal, in response to said monitoring detecting receipt of a beacon signal. In some such embodiments, processor 302 is configured to: compare a time indicated in a received beacon signal to a time indicated at the time of receipt of said received beacon signal by a clock of said communications device, if said monitoring detects receipt of a beacon signal; and set the backoff time to a reduced value, when said comparing indicates that the time indicated in the received beacon signal is less than the time indicated by the clock of said communications device.

In various embodiments, processor 302 is further configured to: transmit the first beacon signal if said backoff time expires during said first beacon slot; and cancel transmission of said first beacon signal if said backoff time does not expire within said first beacon slot. In various embodiments, processor 302 is further configured to: reduce the backoff time at a predetermined rate during said first beacon slot during time when a signal, which exceeds a first power level threshold or is decodable by the communications device, is not being received; and suspend reduction of said backoff time during receipt of a signal which exceeds the first power level threshold or is decodable by the communications device.

In some embodiments, processor 302 is further configured to: compare a time indicated in a received beacon signal to a time indicated at the time of receipt of said received beacon signal by a clock of said communications device, if said monitoring detects receipt of a beacon signal. In some such embodiments processor 302 is further configured to: update the time indicated by the clock of the communications device to match the time indicated in the received beacon signal when said comparing indicates that the time indicated in the received beacon signal is greater than the time indicated by the clock of said communications device; and cancel transmission of the first beacon signal if the power of the received beacon signal exceeds a second power level threshold. In some such embodiments, processor 302 is further configured to alter, e.g., reduce, the backoff time if the power of the received beacon signal is less than the second threshold.

In various embodiments processor 302 is further configured to: determine if a majority of time stamps, received prior to said first beacon slot, included in received beacon signals indicated an earlier time than a time indicated by the clock of the communications device at the time of receipt of the beacon signals; and increase a probability that a short backoff time will be determined as compared to the probability when it is not determined that the majority of time stamps included in received beacon signals indicated an earlier time than the time indicated by the clock of the communications device at the time of receipt of the beacon signals, if it is determined that the majority of time stamps included in received beacon signals indicated an earlier time than the time indicated by the clock of the communications device at the time of receipt of the beacon signals, as part of being configured to determine a backoff time. In some embodiments, processor 302 is configured to increase a probability that a short backoff time will be determined when said communications device transmitted a beacon signal in a beacon slot immediately preceding said first beacon slot, as part of being configured to determine a backoff time.

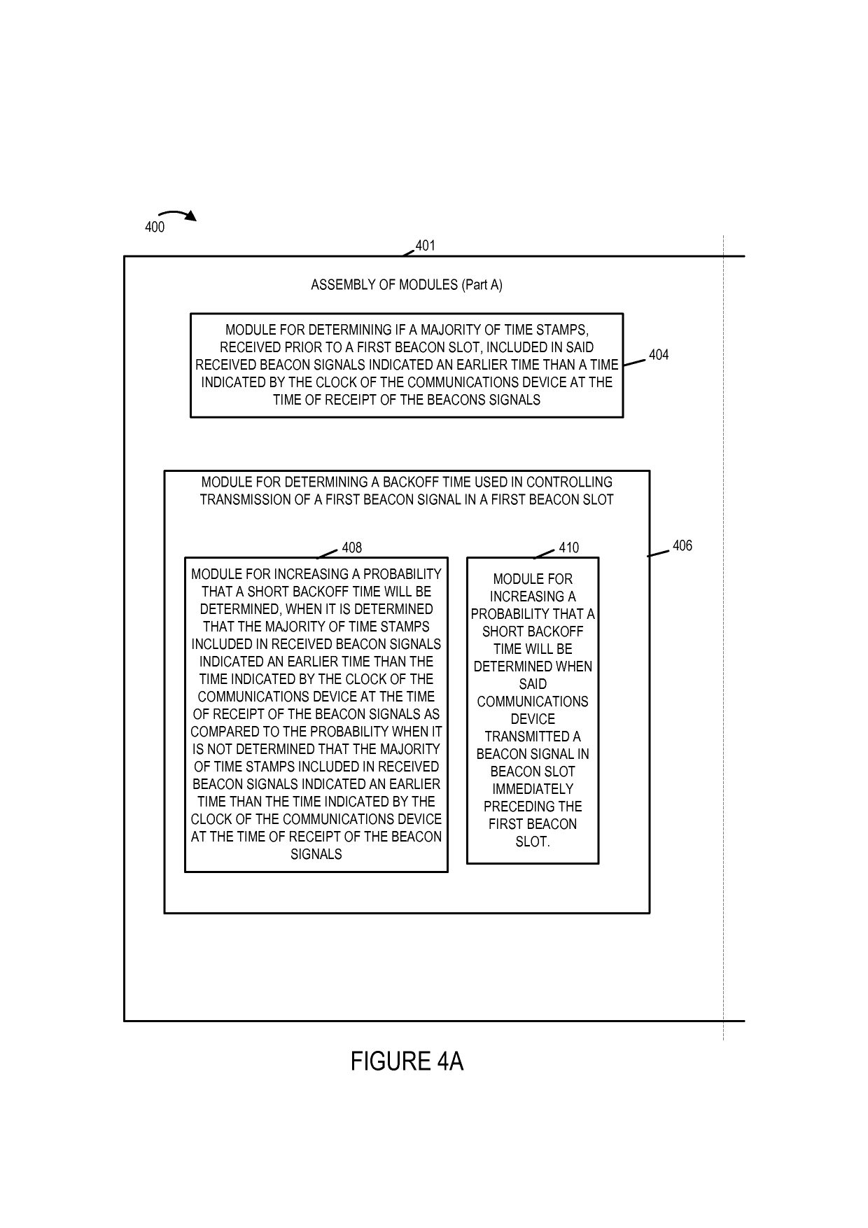

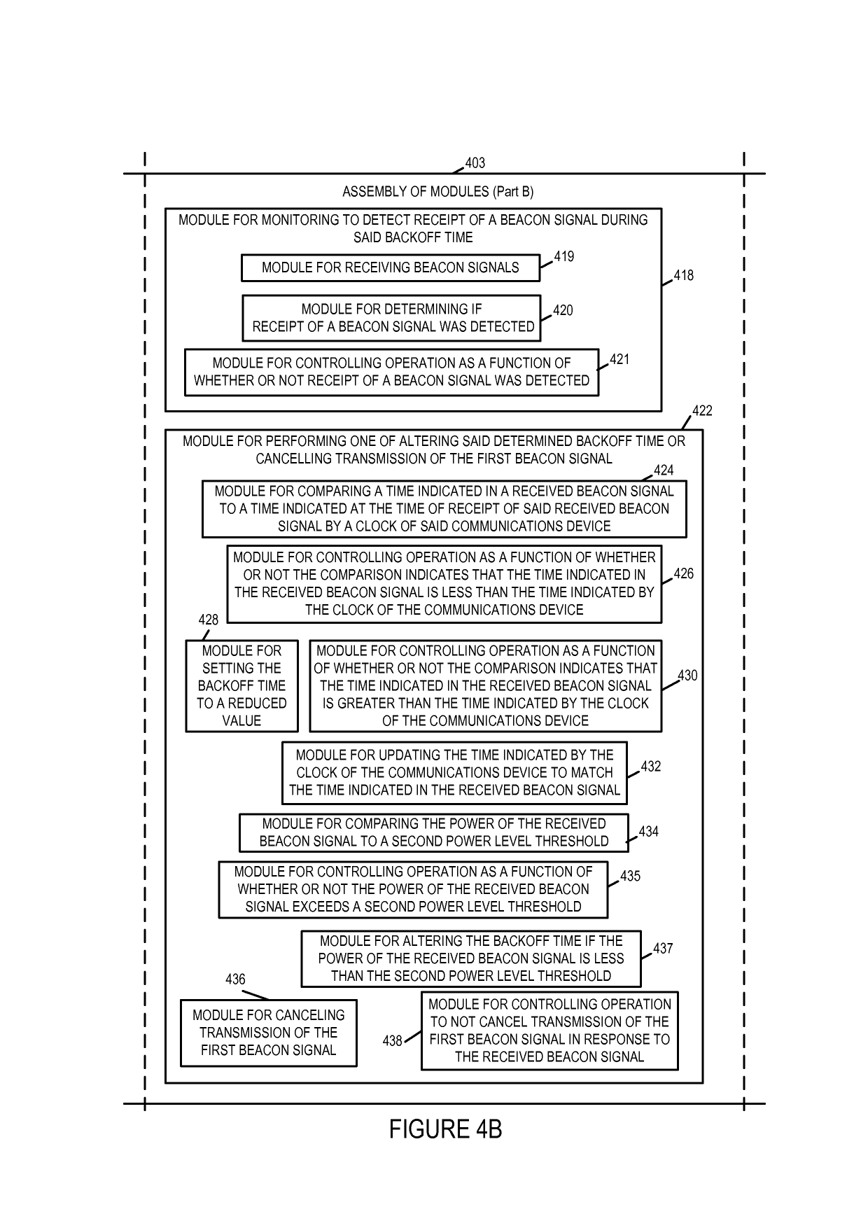

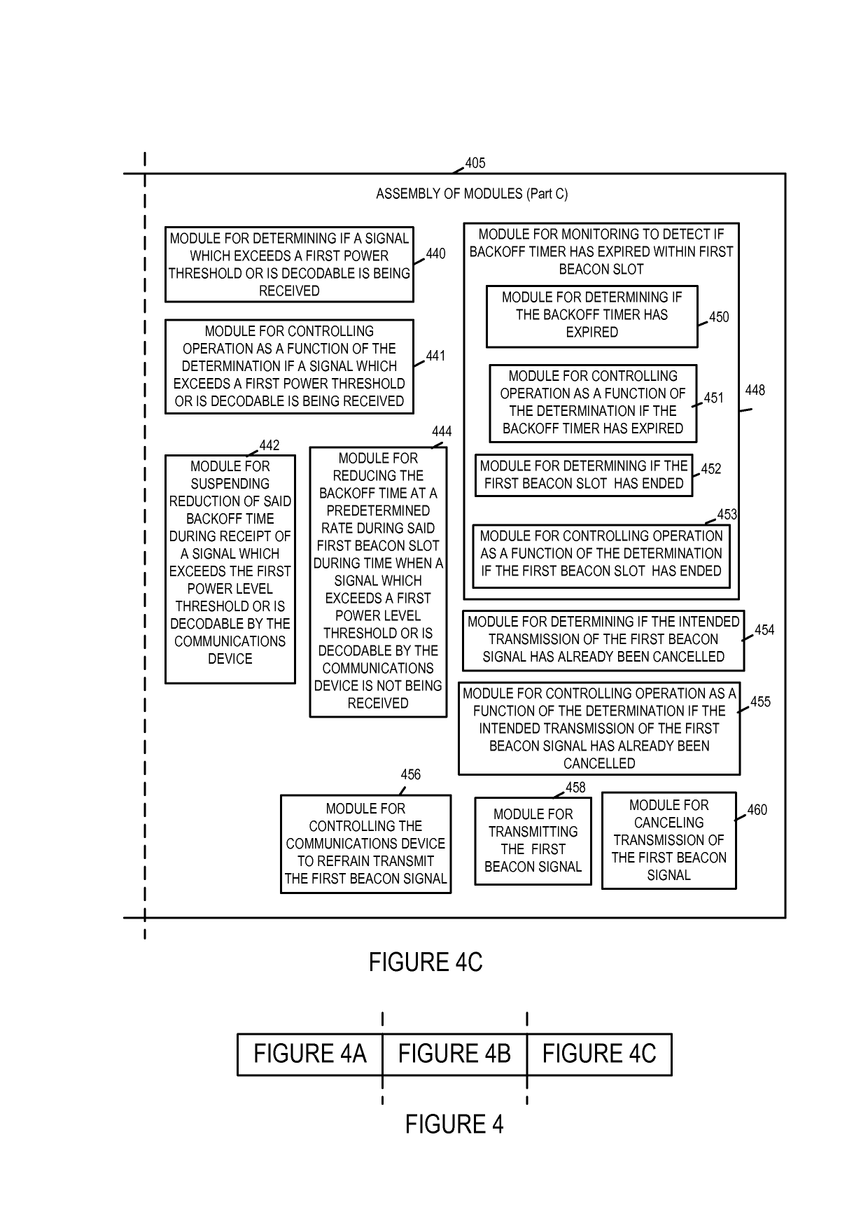

FIG. 4 is an assembly of modules 400 which can, and in some embodiments is, used in the exemplary communications device 300 illustrated in FIG. 3. The modules in the assembly 400 can be implemented in hardware within the processor 302 of FIG. 3, e.g., as individual circuits. Alternatively, the modules may be implemented in software and stored in the memory 304 of wireless communications device 300 shown in FIG. 3. In some such embodiments, the assembly of modules 400 is included in routines 311 of memory 304 of device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium, e.g., a non-transitory computer readable medium, comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the communications device 300 or elements therein such as the processor 302, to perform the functions of the corresponding steps illustrated and/or described in the method of flowchart 200 of FIG. 2.

Assembly of modules 400, comprising the combination of Part A 401, Part B 403 and Part C 405, includes a module for determining if a majority of time stamps received prior to a first beacon slot, included in received beacon signals indicated an earlier time by the clock of the communications device at the time of receipt of the beacon signals 404, a module for determining a backoff time used in controlling transmission of a first beacon signal in a first beacon slot 406, a module for monitoring to detect receipt of a beacon signal during said backoff time 418, and a module for performing one of altering said determined backoff time or cancelling transmission of the first beacon signal in response to said monitoring detecting receipt of a beacon signal 422. Module 406 includes a module for increasing a probability that a short backoff time will be determined when it is determined that the majority of time stamps included in received beacon signals indicated an earlier time than the time indicated by the clock of the communications device at the time of receipt of the beacon signals as compared to the probability when it is not determined that the majority of time stamps indicated in receive beacon signals indicated an earlier time than the time indicated by the clock of the communications device at the time of receipt of the beacon signals 408 and a module for increasing the probability that short backoff time will be determined when said communications device transmitted a beacon signal in a beacon slot immediately preceding the first beacon slot 410.

Module 410 includes a module for receiving beacons signals 419, a module for determining if receipt of a beacon signal was detected 420 and a module for controlling operation as a function of whether or not receipt of a beacon signal was detected 421. Module 422 includes a module for comparing a time indicated in a received beacon signal to a time indicated at the time of receipt of said received beacon signal by a clock of said communications device if said monitoring detects receipt of a beacon signal 424, a module for controlling operation as a function of whether or not the comparison indicates that the time indicated in the received beacon signal is less than the time indicated by the clock of the communications device 426, a module for setting the backoff time to a reduced value when said comparing indicates that the time indicated in the received beacon signal is less than the time indicated by the clock of the communications device 428, a module for controlling operation as a function of whether or not the comparison indicates that the time indicated in the received beacon signal is greater than the time indicated by the clock of the communications device 430, a module for updating time indicated by the clock of the communications device to match the time indicated in the received beacon signal when said comparing indicates that the time in the received beacon signal is greater than the time indicated by the clock of said communications device 432, a module for comparing the power of the received beacon signal to a second power threshold level 434, a module for controlling operation as a function of whether or not the power of the received beacon signal exceeds a second power threshold 435, a module for canceling transmission of the first beacon signal if the power of the received beacon signal exceeds a second power level threshold 436, a module for altering the backoff time, e.g., setting the backoff time to a reduced value, if the power of the received beacon signal is less than the second power level threshold 437, and a module for controlling operation to not cancel transmission of the first beacon signal in response to the received beacon signal 438.

Assembly of modules 400 further includes a module for determining if a signal which exceeds a first power level threshold or is decodable is being received 440, a mdoue for controlling operation as a function of the determination of a signal which exceeds a first power threshold or is decodable is being received 441, a module suspending reduction of said backoff time during receipt of a signal which exceeds the first power level threshold or is decodable by the communications device 442 and a module for reducing the backoff time at a predetermined rate during said first beacon slot during time when a signal which exceeds a first power threshold or is decodable by the communications device is not being received 444. Assembly of modules 400 further includes a module for monitoring to detect if a backoff timer has expired with the first beacon slot, 448, a module for determining if the intended transmission of the first beacon signal has already been cancelled 454, a module for controlling operation as a function of the determination if the intended transmission of the first beacon signal has already been cancelled 455, a module for controlling the communications device to refrain from transmitting the first beacon signal 456, a module for transmitting the first beacon signal if said backoff time expires during said first beacon slot 458 and a module for canceling transmission of the first beacon signal if the backoff time does not expire within said first beacon slot 460. Module 448 includes a module for determining if the backoff timer has expired 450, a module for controlling operation as a function of the determination if the backoff timer has expired 451, a module for determining if the first beacon slot has ended 452, and a module for controlling operation as a function of the determination if the first beacon slot has ended 453.

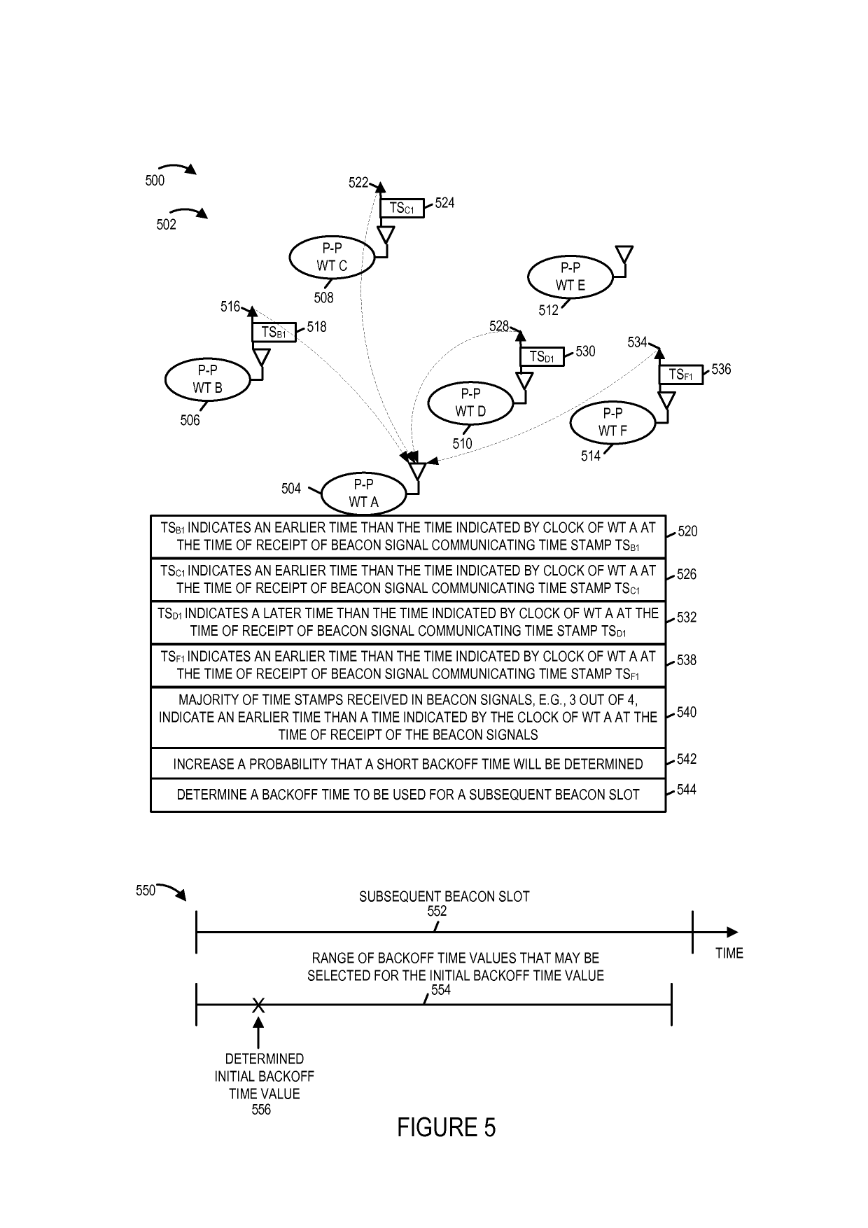

FIGS. 5-12 illustrates several examples to which illustrate various features and/or aspects of some embodiments. Drawing 500 of FIG. 5 illustrates an exemplary peer to peer wireless terminal A 504 determining a backoff time, used to control transmission of a beacon signal, based on information corresponding to received beacon signals from a prior beacon slot in accordance with an exemplary embodiment. Drawing 502 illustrates an exemplary peer to peer network, e.g., an ad hoc peer to peer network, including a plurality of peer to peer wireless terminals (peer to peer wireless terminal A 504, peer to peer wireless terminal B 506, peer to peer wireless terminal C 508, peer to peer wireless terminal D 510, peer to peer wireless terminal E 512, peer to peer wireless terminal F 514). Wireless terminals (502, 504, 506, 508, 510, 512, 514) are, e.g., any of the peer to peer wireless terminal of system 100 of FIG. 1 and/or a wireless communications device implementing a method in accordance with flowchart 200 of FIG. 2 and/or a wireless communications device implemented in accordance with device 300 of FIG. 3 and/or including the assembly of modules 400 of FIG. 4.

WT B 506 generates and transmits beacon signal 516 including time stamp TS_{B1} 518. WT A receives beacon signal 516 and determines that TS_{B1} indicates an earlier time than the time indicated by the clock of WT A at the time of receipt of beacon signal 516 communicating time stamp TS_{B1} 518, as indicated by box 520.

WT C 508 generates and transmits beacon signal 522 including time stamp TS_{C1} 524. WT A receives beacon signal 522 and determines that TS_{C1} indicates an earlier time than the time indicated by the clock of WT A at the time of receipt of beacon signal 522 communicating time stamp TS_{C1} 524, as indicated by box 526.

WT D 510 generates and transmits beacon signal 528 including time stamp TS_{D1} 530. WT A receives beacon signal 528 and determines that TS_{D1} indicates a later time than the time indicated by the clock of WT A at the time of receipt of beacon signal 528 communicating time stamp TS_{D1} 530, as indicated by box 532.

WT F 514 generates and transmits beacon signal 534 including time stamp TS_{F1} 536. WT A receives beacon signal 534 and determines that TS_{F1} indicates an earlier time than the time indicated by the clock of WT A at the time of receipt of beacon signal 534 communicating time stamp TS_{F1} 536, as indicated by box 538.

WT A 504 determines that a majority of time stamps received in beacon signals, e.g., 3 out of 4 in this example, indicate an earlier time than a time indicated by the clock of WT A at the time of receipt of the beacon signals, as indicated by box 540. In response to the determination of step 540, wireless terminal A 504 increases a probability that a short backoff time will be determined, as indicated by box 542. Wireless terminal A 504 determines a backoff time to be used for a subsequent beacon slot using the probability adjustment of box 542, as indicated in box 544.

Drawing 550 of FIG. 5 illustrates an exemplary subsequent beacon slot 552, a range of backoff time values that may be selected for the initial backoff time value 554 and an exemplary determined initial backoff time value 556 corresponding to the determination of step 544.

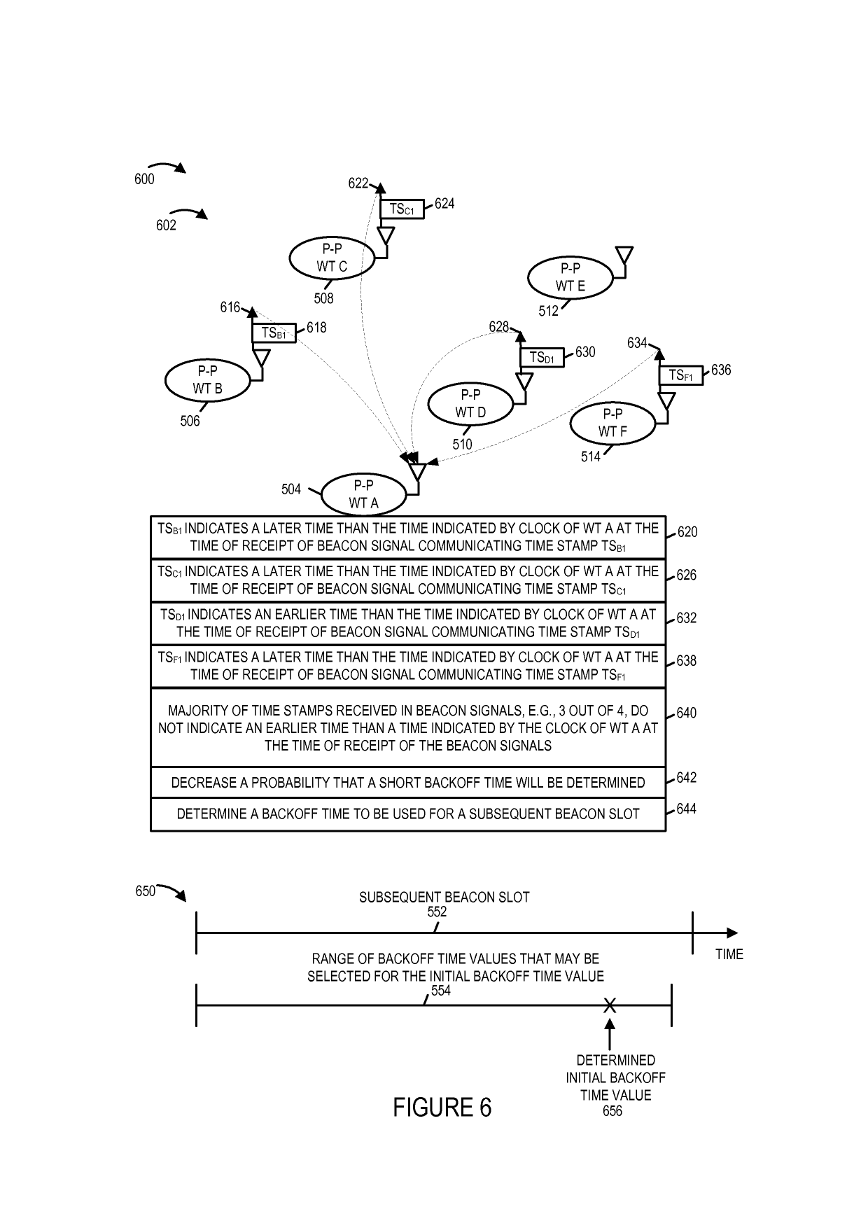

Drawing 600 of FIG. 6 illustrates an exemplary peer to peer wireless terminal A 504 determining a backoff time, used to control transmission of a beacon signal, based on information corresponding to received beacon signals from a prior beacon slot in accordance with an exemplary embodiment. Drawing 602 illustrates an exemplary peer to peer network, e.g., an ad hoc peer to peer network, including a plurality of peer to peer wireless terminals (peer to peer wireless terminal A 504, peer to peer wireless terminal B 506, peer to peer wireless terminal C 508, peer to peer wireless terminal D 510, peer to peer wireless terminal E 512, peer to peer wireless terminal F 514).

WT B 506 generates and transmits beacon signal 616 including time stamp TS_{B1} 618. WT A receives beacon signal 616 and determines that TS_{B1} indicates a later time than the time indicated by the clock of WT A at the time of receipt of beacon signal 616 communicating time stamp TS_{B1} 618, as indicated by box 620.

WT C 508 generates and transmits beacon signal 622 including time stamp TS_{C1} 624. WT A receives beacon signal 622 and determines that TS_{C1} indicates a later time than the time indicated by the clock of WT A at the time of receipt of beacon signal 622 communicating time stamp TS_{C1} 624, as indicated by box 626.

WT D 510 generates and transmits beacon signal 628 including time stamp TS_{D1} 630. WT A receives beacon signal 628 and determines that TS_{D1} indicates an earlier time than the time indicated by the clock of WT A at the time of receipt of beacon signal 628 communicating time stamp TS_{D1} 630, as indicated by box 632.

WT F 514 generates and transmits beacon signal 634 including time stamp TS_{F1} 636. WT A receives beacon signal 634 and determines that TS_{F1} indicates a later time than the time indicated by the clock of WT A at the time of receipt of beacon signal 634 communicating time stamp TS_{F1} 636, as indicated by box 638.

WT A 504 determines that a majority of time stamps received in beacon signals, e.g., 3 out of 4 in this example, do not indicate an earlier time than a time indicated by the clock of WT A at the time of receipt of the beacon signals, as indicated by box 640. In response to the determination of step 640, wireless terminal A 504 decreases a probability that a short backoff time will be determined, as indicated by box 642. Wireless terminal A 504 determines a backoff time to be used for a subsequent beacon slot using the probability adjustment indicated in step 642, as indicated in box 644.

Drawing 650 of FIG. 6 illustrates an exemplary subsequent beacon slot 552, a range of backoff time values that may be selected for the initial backoff time value 554 and an exemplary determined initial backoff time value 656 corresponding to the determination of step 644.

FIG. 5 and FIG. 6 may correspond to different examples, e.g., different iterations, of executing steps 204 and 206 of flowchart 200 where exemplary peer to peer wireless terminal A 504 is implementing the method of flowchart 200 of FIG. 2.

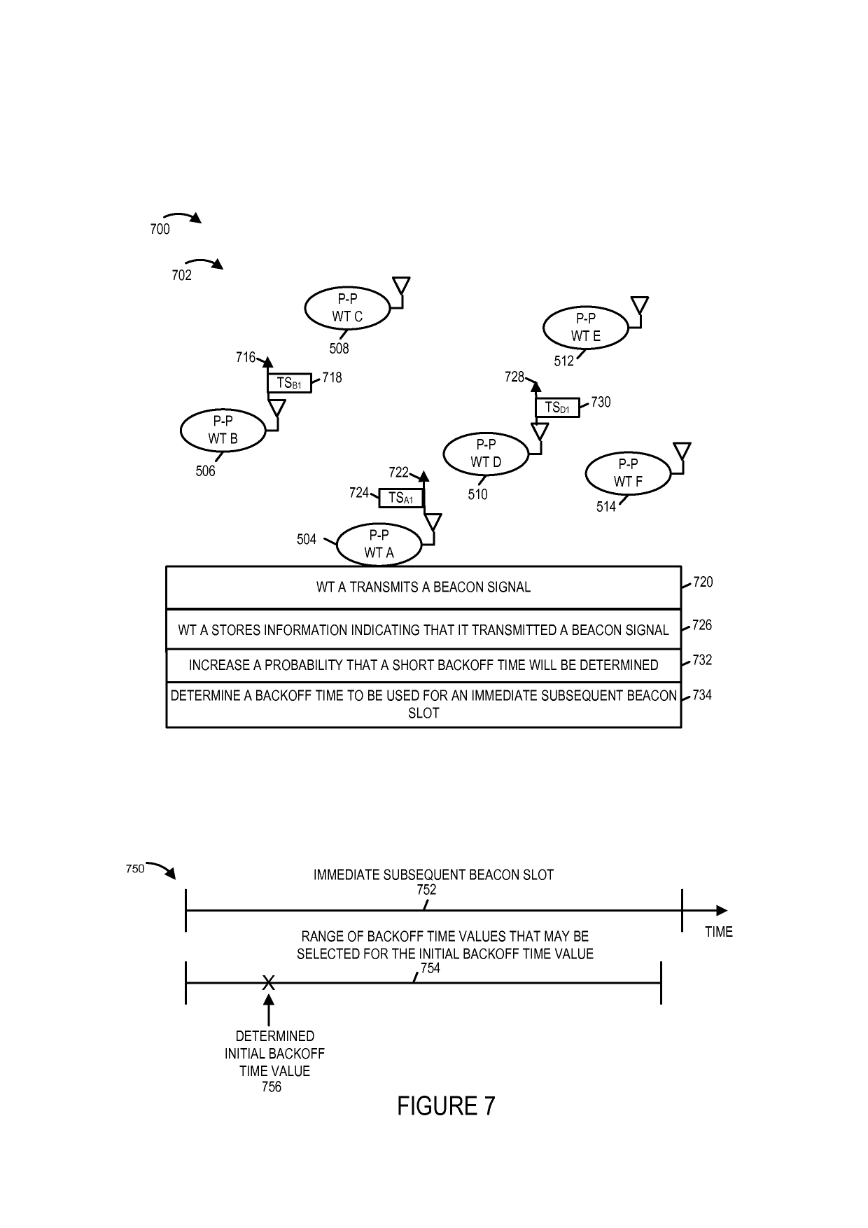

Drawing 700 of FIG. 7 illustrates an exemplary peer to peer wireless terminal A 504 determining a backoff time, used to control transmission of a beacon signal, based on whether or not WT A 504 transmitted a beacon in an immediately preceding beacon slot in accordance with an exemplary embodiment. Drawing 702 illustrates an exemplary peer to peer network, e.g., an ad hoc peer to peer network, including a plurality of peer to peer wireless terminals (peer to peer wireless terminal A 504, peer to peer wireless terminal B 506, peer to peer wireless terminal C 508, peer to peer wireless terminal D 510, peer to peer wireless terminal E 512, peer to peer wireless terminal F 514).

WT B 506 generates and transmits beacon signal 716 including time stamp TS_{B1} 718. WT A 504 generates and transmits beacon signal 722 including time stamp TS_{A1} 724, as indicated by block 720. WT A 504 stores information indicating that it has transmitted a beacon signal during this beacon slot, as indicated by block 726. WT D 510 generates and transmits beacon signal 728 including time stamp TS_{D1} 730. WT A 504 increases a probability that a short backoff time will be determined for the immediate subsequent beacon slot in response to WT A having transmitted a beacon signal, as indicated by block 732. Wireless terminal A 504 determines a backoff time to use as an initial backoff time value for an immediate subsequent beacon slot based on increase in probability of step 732, as indicated in block 734.

Drawing 750 of FIG. 7 illustrates an exemplary immediate subsequent beacon slot 752, a range of backoff time values that may be selected for the initial backoff time value 754 and an exemplary determined initial backoff time value 756 corresponding to the determination of step 734.

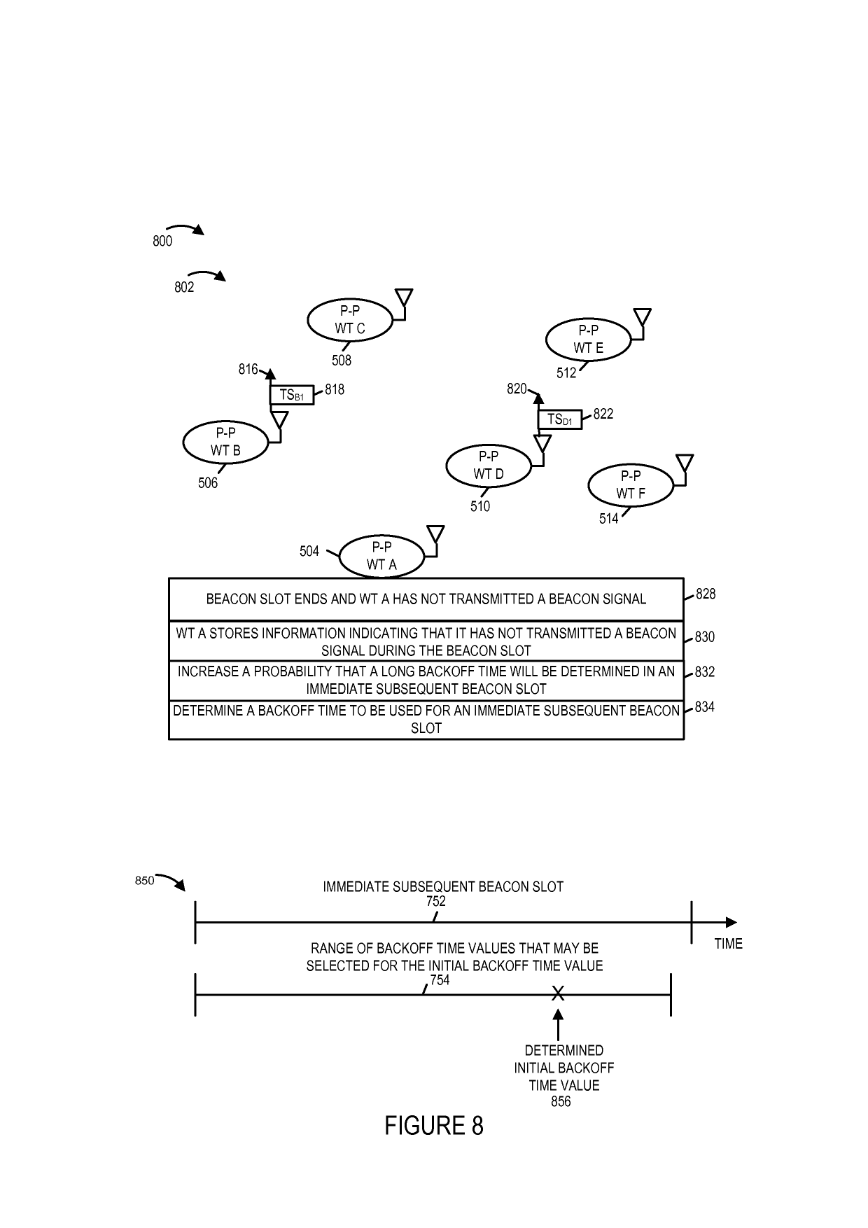

Drawing 800 of FIG. 8 illustrates an exemplary peer to peer wireless terminal A 504 determining a backoff time, used to control transmission of a beacon signal, based on whether or not WT A 504 transmitted a beacon in an immediately preceding beacon slot in accordance with an exemplary embodiment. Drawing 802 illustrates an exemplary peer to peer network, e.g., an ad hoc peer to peer network, including a plurality of peer to peer wireless terminals (peer to peer wireless terminal A 504, peer to peer wireless terminal B 506, peer to peer wireless terminal C 508, peer to peer wireless terminal D 510, peer to peer wireless terminal E 512, peer to peer wireless terminal F 514).

WT B 506 generates and transmits beacon signal 816 including time stamp TS_{B1} 818. WT D 510 generates and transmits beacon signal 820 including time stamp TS_{D1} 822. WT A 504 detects that the beacon slot has ended and WT A 504 has not transmitted a beacon signal, as indicated by block 828. WT A 504 stores information indicating that it has not transmitted a beacon signal during the beacon slot, as indicated by block 830. WT A 504 increases a probability that a long backoff time will be determined for the immediate subsequent beacon slot in response to WT A not having transmitted a beacon signal, as indicated by block 832. Wireless terminal A 504 determines a backoff time to use as an initial backoff time value for an immediate subsequent beacon slot based on probability adjustment of step 832, as indicated in block 834.

Drawing 850 of FIG. 8 illustrates an exemplary immediate subsequent beacon slot 752, a range of backoff time values that may be selected for the initial backoff time value 754 and an exemplary determined initial backoff time value 856 corresponding to the determination of step 834.

FIG. 7 and FIG. 8 may correspond to different examples, e.g., different iterations, of executing steps 206 of flowchart 200 where exemplary peer to peer wireless terminal A 504 is implementing the method of flowchart 200 of FIG. 2.

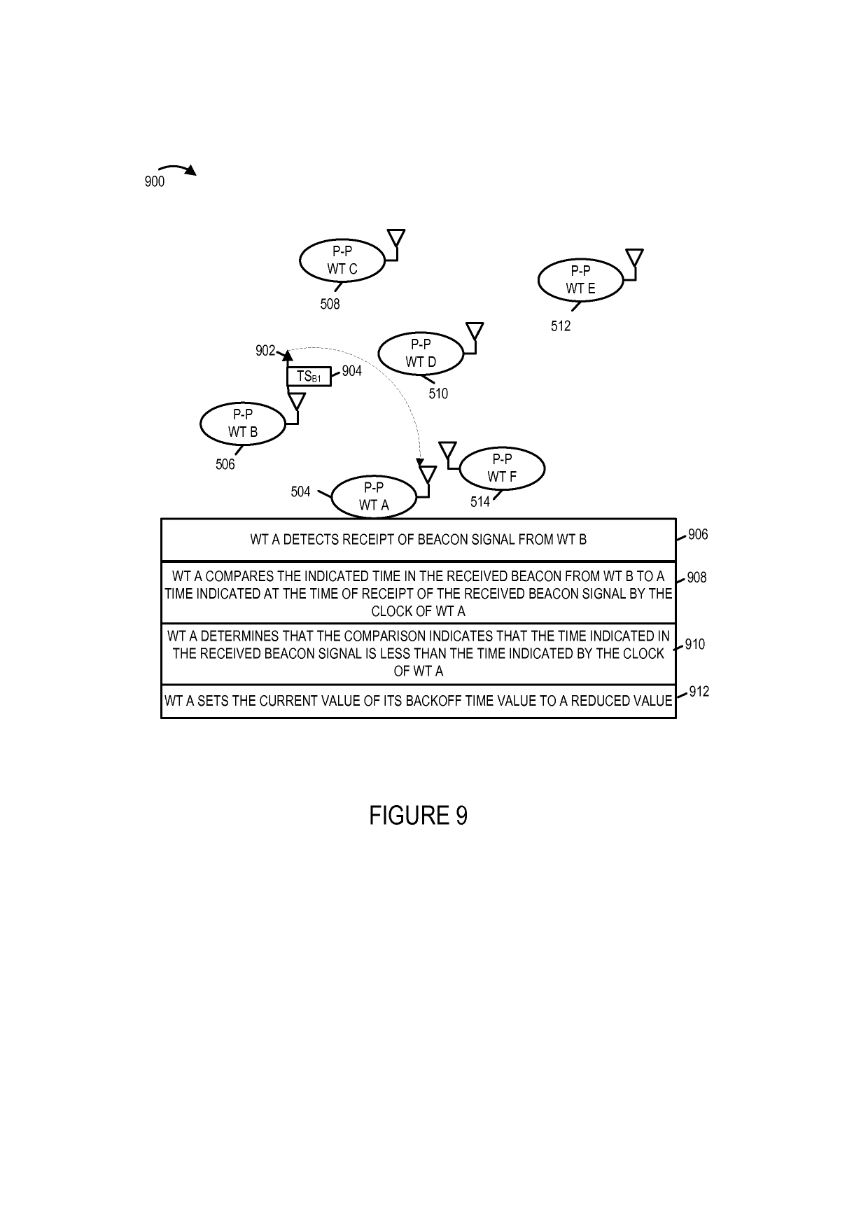

Drawing 900 of FIG. 9 illustrates an exemplary peer to peer wireless terminal A 504 reducing its current value of its backoff time value in response to detecting a beacon signal from another wireless terminal with characteristics that satisfies particular criteria in accordance with an exemplary embodiment. Drawing 900 illustrates an exemplary peer to peer network, e.g., an ad hoc peer to peer network, including a plurality of peer to peer wireless terminals (peer to peer wireless terminal A 504, peer to peer wireless terminal B 506, peer to peer wireless terminal C 508, peer to peer wireless terminal D 510, peer to peer wireless terminal E 512, peer to peer wireless terminal F 514).

WT B 506 generates and transmits beacon signal 902 including time stamp TS_{B1} 904. WT A 504 detects receipt of beacon signal 902 from WT B 506, as indicated by block 906. WT A 504 compares the indicated time in the received beacon from WT B, e.g., the time indicated in time stamp TS_{B1} 904, to a time indicated at the time of receipt of beacon signal 902 by the clock of WT A 504, as indicated by block 908. In this example, WT A 504 determines that the comparison indicates that the time indicated in the received beacon signal is less than the time indicated by the clock of WT A 504, as indicated by block 910. WT A 504 sets the current value of its backoff time value to a reduced value in response to the determination of step 910, as indicated in block 912.

FIG. 9 may correspond to an example of executing steps 218, 220, 222, 224, 226 and 228 of flowchart 200 where exemplary peer to peer wireless terminal A 504 is implementing the method of flowchart 200 of FIG. 2.

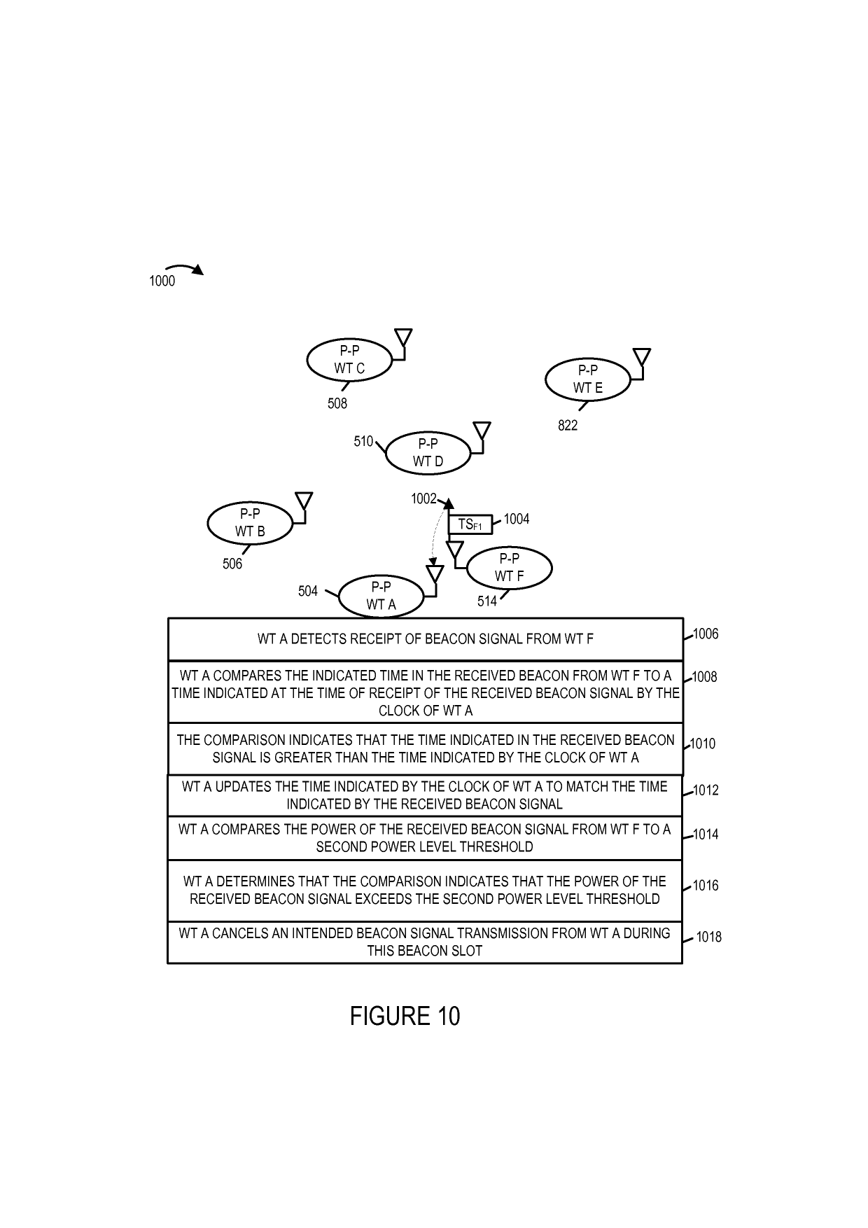

Drawing 1000 of FIG. 10 illustrates an exemplary peer to peer wireless terminal A 504 cancelling an intended beacon signal transmission in response to detecting a beacon signal from another wireless terminal with characteristics that satisfies particular criteria in accordance with an exemplary embodiment. Drawing 1000 illustrates an exemplary peer to peer network, e.g., an ad hoc peer to peer network, including a plurality of peer to peer wireless terminals (peer to peer wireless terminal A 504, peer to peer wireless terminal B 506, peer to peer wireless terminal C 508, peer to peer wireless terminal D 510, peer to peer wireless terminal E 512, peer to peer wireless terminal F 514).

WT F 514 generates and transmits beacon signal 1002 including time stamp TS_{F1} 1004. WT A 504 detects receipt of beacon signal 1002 from WT F 514, as indicated by block 1006. WT A 504 compares the indicated time in the received beacon from WT F, e.g., the time indicated in time stamp TS_{F1} 1004, to a time indicated at the time of receipt of beacon signal 902 by the clock of WT A 504, as indicated by block 1008. In this example, WT A 504 determines that the comparison indicates that the time indicated in the received beacon signal is greater than the time indicated by the clock of WT A 504, as indicated by block 1010. WT A 504 updates the time indicated by the clock of WT A to match the time indicated by the received beacons signal, as indicated by block 1012. Thus WT A synchronizes to the faster clock of WT F.

WT A 504 compares the power of the received beacon from WT A to a second power level threshold, as indicated in block 1014. In this example, WT A determines that the comparison indicates the power of the received beacon signal exceeds the second power level threshold, as indicated by block 1016. In response to the determination that the comparison indicates that the power level of the received beacon signals exceeds the second power level threshold, WT A cancels the intended beacon signal transmission from WT A during this current beacon slot, as indicated by block 1018.

FIG. 10 may correspond to an example of executing steps 218, 220, 222, 224, 226, 230, 232, 234 and 236 of flowchart 200 where exemplary peer to peer wireless terminal A 504 is implementing the method of flowchart 200 of FIG. 2.

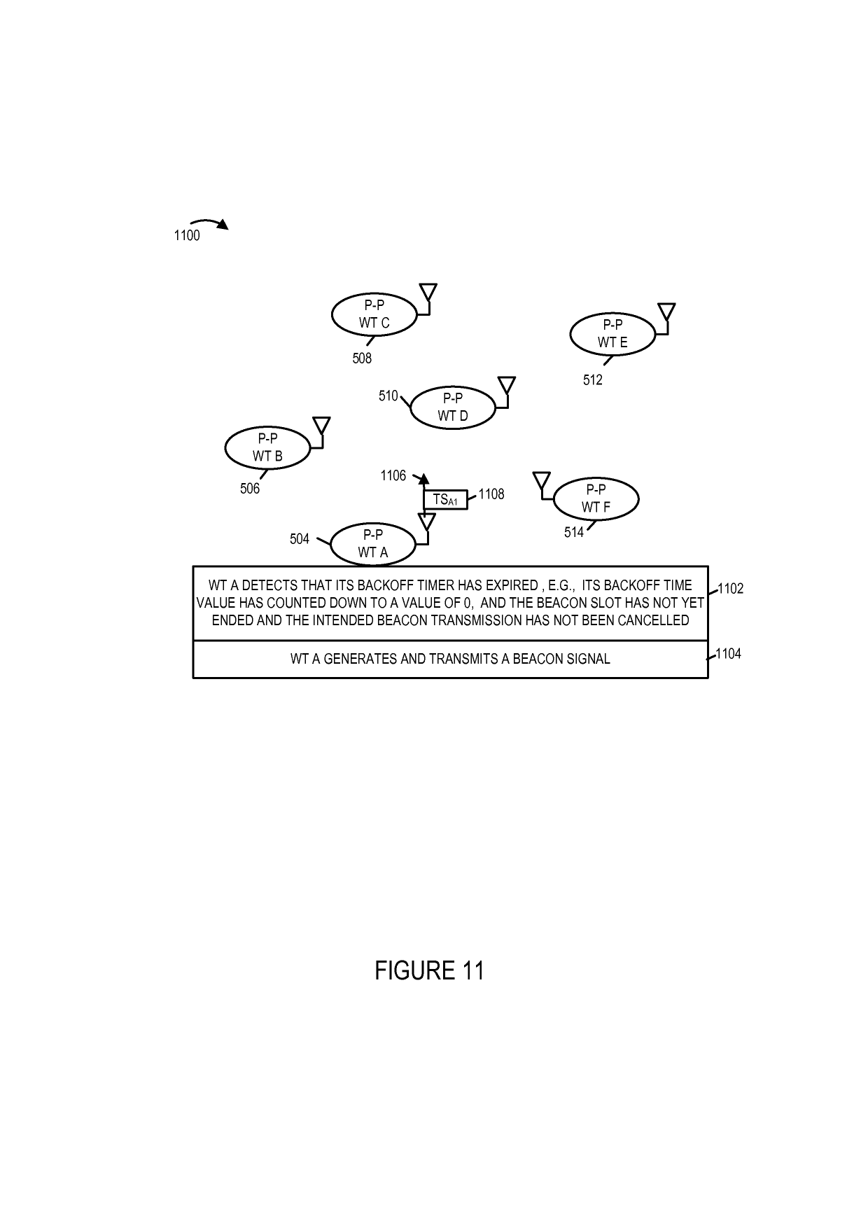

Drawing 1100 of FIG. 11 illustrates an exemplary peer to peer wireless terminal A 504 transmitting an intended beacon signal transmission in response to detecting that its backoff timer has expired within the current beacon slot in accordance with an exemplary embodiment. Drawing 1100 illustrates an exemplary peer to peer network, e.g., an ad hoc peer to peer network, including a plurality of peer to peer wireless terminals (peer to peer wireless terminal A 504, peer to peer wireless terminal B 506, peer to peer wireless terminal C 508, peer to peer wireless terminal D 510, peer to peer wireless terminal E 512, peer to peer wireless terminal F 514).

WT A 504 detects that its backoff timer has expired, e.g., its backoff time value has counted down to a value of zero, and the beacon slot has not yet ended and the intended beacon transmission from WT A has not been cancelled, as indicated by block 1102. WT A 504 generates and transmits beacon signal 1106 communicating time stamp TS_{A1} 1108. The transmitted beacon signal 1106 may be received and processed by the other wireless terminals in the network (506, 508, 510, 512, 514) which may also be implementing a method in accordance with flowchart 200 of FIG. 2.

FIG. 11 may correspond to an example of executing steps 248, 250, 252, 254, and 258 of flowchart 200 where exemplary peer to peer wireless terminal A 504 is implementing the method of flowchart 200 of FIG. 2.

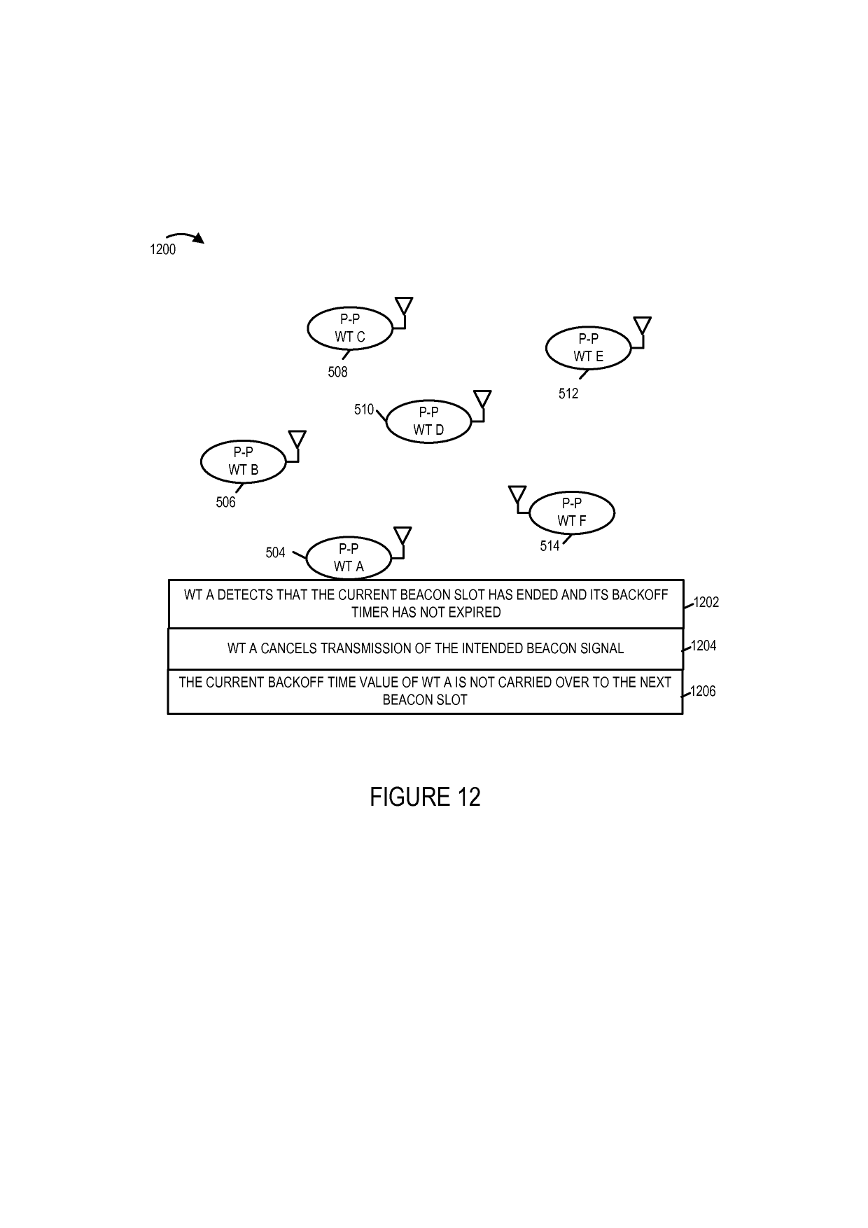

Drawing 1200 of FIG. 12 illustrates an exemplary peer to peer wireless terminal A 504 cancelling an intended beacon signal transmission in response to detecting that the current beacon slot has expired in accordance with an exemplary embodiment. Drawing 1200 illustrates an exemplary peer to peer network, e.g., an ad hoc peer to peer network, including a plurality of peer to peer wireless terminals (peer to peer wireless terminal A 504, peer to peer wireless terminal B 506, peer to peer wireless terminal C 508, peer to peer wireless terminal D 510, peer to peer wireless terminal E 512, peer to peer wireless terminal F 514).

WT A 504 detects that the current beacon slot has ended and its backoff timer has not expired, as indicated by block 1202. WT A cancels transmission of its intended beacon signal in response to the beacon slot ending, as indicated in block 1204. The current backoff time value of WT is not carried over to the next beacon slot in this embodiment, as indicated by block 1206.

FIG. 12 may correspond to an example of executing steps 248, 250, 252, and 260 of flowchart 200 where exemplary peer to peer wireless terminal A 504 is implementing the method of flowchart 200 of FIG. 2.

Various features and/or aspects of some, but not necessarily all embodiments, will be further discussed. In various embodiments distributed synchronization is achieved without infrastructure, e.g., without a base station or central control node. Various embodiments are well suited for use in social WiFi applications for achieving synchronization between devices. Various benefits over existing approaches to synchronization include, e.g., power savings and/or collision avoidance between discovery messages. Some embodiments offer improvements over a current 802.11 synchronization protocol. Some deficiencies of current 802.11 synchronization protocol include slow dissemination of clock in the presence of multi-hop and no way to measure clock rates.

In some exemplary embodiments there can be, and sometimes are, multiple winners per beacon election, e.g., multiple wireless communications device may transmit their beacon used for timing synchronization during the same beacon slot. Various exemplary methods and apparatus are directed to determining the winners, e.g., determining whether a particular wireless communications device transmits its beacon signal during a particular beacon slot, e.g., based on the characteristics of received beacon signals from other devices. In various embodiments, priority to beacon transmission is given to a previous winner to facilitate clock skew estimation. For example, in some embodiments the exemplary method increases the probability that a wireless communications device which has transmitted a beacon in a first beacon slot will transmit a beacon in a second beacon slot, where the first beacon slot is the beacon slot immediately preceding the second beacon slot. Successive beacon signal transmission from the same wireless communications device during two successive beacon slots facilitates clock skew estimation by the other devices receiving the two beacon signals.

In various embodiments, the feature of allowing multiple winners per beacon slot facilitates faster dissemination of timing synchronization over an approach where one beacon is allowed to transmit in a beacon slot. Thus in various embodiments, multiple wireless communications devices may, and sometimes do, transmit a beacon in the same beacon slot even if they detect a beacon from another device.

In some embodiments, a wireless communications device is a client station (STA). In some embodiments, for a beacon slot, each client station (STA) initially selects a backoff used in controlling transmission of beacon signal during the beacon slot, e.g., a pseudo-random backoff. Consider the operations of an individual STA. In some embodiments, if the STA receives a beacon before the timer expires, the STA performs one of: (i) cancelling transmission of its intended beacon, (ii) keeping the back-off as it is, or (iii) reducing its current back-off value, depending upon characteristics of the received beacon signal. The STA cancels the intended beacon transmission if the T(beacon)>T(STA) and the beacon power of the received beacon is greater than a threshold, where T(beacon) is a time indicated in the received beacon and T(STA) is a time indicated at the time of receipt of the received beacon by a clock of the STA receiving the beacon. The STA keeps the back off as is if the T(beacon)>T(STA) and the beacon power is less than the threshold. The STA reduces the back off if the T(beacon)<T(STA), since in this case the STA is faster than the beacon. In this situation it is desirable that the STA be able to transmit its beacon in the current beacon slot and by reducing the current backoff time value of the STA, the probability that the STA will transmit its beacon in the current beacon slot is increased. In some embodiments, the amount of the reduction in the backoff is a function of the time difference between T(beacon) and T(STA), e.g., the larger the time difference the higher the amount of reduction in the current backoff time value of STA in response to the detected beacon. Step 222 of flowchart 200 of Figure illustrates an exemplary method that is used by a wireless communications device, e.g., a STA, in some embodiments, to respond to a detected beacon signal.

In various embodiments, one goal of the synchronization is to converge to the fastest clock. In some such embodiments, the exemplary method prioritizes successive transmissions from fast clocks to facilitate skew estimation. In one exemplary embodiment, a STA determines if it has a fast clock, e.g., based on the time adjustments that the STA needs to make. In some embodiments, an STA considers that it has a fast clock if the STA wins beacon election for beacon slot t and does not adjust its time, e.g., transmits a beacon in beacon slot t and does not adjust its time based on received beacons from other devices in beacon slot t. Then the STA contends in beacon slot t+1 with a short backoff time. Thus, a short backoff time is selected for the next successive beacon slot increasing the likelihood that the STA will transmit a beacon in beacon slot t+1. Step 210 of flowchart 200 of FIG. 2 illustrates an example of this approach. In some embodiments, the STA defaults back to a standard protocol for beacon slot t+2, e.g., the increase in priority resulting in a lower backoff time for slot t+1 is not applicable to slot t+2, even if the STA has transmitted a beacon in slot t+1 and has not adjusted its timing based on received beacons from other devices in slot t+1.

In various embodiments a device, e.g., a peer to peer wireless communications device in system 100 of FIG. 1, and/or communication device 300 of FIG. 3, and/or one of the wireless terminals (506, 508, 510 512, 514) or FIGS. 5-12 includes a module corresponding to each of the individual steps and/or operations described with regard to any of the Figures in the present application and/or described in the detailed description of the present application. In some embodiments, the modules are implemented in hardware, e.g., in the form of circuits. Thus, in at least some embodiments the modules may, and sometimes are implemented in hardware. In other embodiments, the modules may, and sometimes are, implemented as software modules including processor executable instructions which when executed by the processor of the communications device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., network nodes, mobile nodes such as mobile terminals supporting peer to peer communications, access points such as base stations, and/or communications systems. Various embodiments are also directed to methods, e.g., method of controlling and/or operating network nodes, mobile nodes, access points such as base stations and/or communications systems, e.g., hosts. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal processing, signal generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more methods of the invention.

In some embodiments, the processor or processors, e.g., CPUs, of one or more devices, e.g., communications nodes such as network nodes, access nodes and/or wireless terminals, are configured to perform the steps of the methods described as being performed by the communications nodes. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a device, e.g., a communications node, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer signaling protocol. Some embodiments use an Orthogonal Frequency Division Multiplexing (OFDM) based wireless peer to peer signaling protocol, e.g., WiFi signaling protocol or another OFDM based protocol.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with Code Division Multiple Access (CDMA), OFDM, and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating a communications device, comprising:
determining a backoff time used in controlling transmission of a first beacon signal in a first beacon slot;
monitor to detect receipt of a beacon signal during said backoff time; and
in response to said monitoring detecting receipt of a beacon signal performing one of: altering said determined backoff time or canceling transmission of the beacon signal.

2. The method of claim 1, further comprising:
if said monitoring detects receipt of a beacon signal, comparing a time indicated in a received beacon signal to a time indicated at the time of receipt of said received beacon signal by a clock of said communications device; and
when said comparing indicates that the time indicated in the received beacon signal is less than the time indicated by the clock of said communications device, setting the backoff time to a reduced value.

3. The method of claim 2, further comprising:
if said backoff time expires during said first beacon slot, transmitting the first beacon signal; and
if said backoff time does not expire within said first beacon slot, canceling transmission of said first beacon signal.

4. The method of claim 3, further comprising:
reducing the backoff time at a predetermined rate during said first beacon slot during time when a signal which: exceeds a first power level threshold or is decodable by the communications device, is not being received; and
suspending reduction of said backoff time during receipt of a signal which exceeds the first power level threshold or is decodable by the communications device.

5. The method of claim 1, further comprising:
if said monitoring detects receipt of a beacon signal, comparing a time indicated in a received beacon signal to a time indicated at the time of receipt of said received beacon signal by a clock of said communications device; and
when said comparing indicates that the time indicated in the received beacon signal is greater than the time indicated by the clock of said communications device:
update the time indicated by the clock of the communications device to match the time indicated in the received beacon signal; and
canceling transmission of the first beacon signal if the power of the received beacon signal exceeds a second power level threshold.

6. The method of claim 1, further comprising:
determining if a majority of time stamps, received prior to said first beacon slot, included in received beacon signals indicated an earlier time than a time indicated by the clock of the communications device at the time of receipt of the beacon signals; and
if it is determined that the majority of time stamps included in received beacon signals indicated an earlier time than the time indicated by the clock of the communications device at the time of receipt of the beacon signals, said step of determining a backoff time includes increasing a probability that a short backoff time will be determined as compared to the probability when it is not determined that the majority of time stamps included in received beacon signals indicated an earlier time than the time indicated by the clock of the communications device at the time of receipt of the beacon signals.

7. The method of claim 1, wherein determining a backoff time includes increasing a probability that a short backoff time will be determined when said communications device transmitted a beacon signal in a beacon slot immediately preceding said first beacon slot.

8. A communications device comprising:
means for determining a backoff time used in controlling transmission of a first beacon signal in a first beacon slot;
means for monitoring to detect receipt of a beacon signal during said backoff time; and
means for performing one of: altering said determined backoff time or canceling transmission of the beacon signal, in response to said monitoring detecting receipt of a beacon signal.

9. The communications device of claim 8, further comprising:
means for comparing a time indicated in a received beacon signal to a time indicated at the time of receipt of said received beacon signal by a clock of said communications device, if said monitoring detects receipt of a beacon signal; and
means for setting the backoff time to a reduced value, when said comparing indicates that the time indicated in the received beacon signal is less than the time indicated by the clock of said communications device.

10. The communications device of claim 9, further comprising:
means for transmitting the first beacon signal, if said backoff time expires during said first beacon slot; and
means for canceling transmission of said first beacon signal, if said backoff time does not expire within said first beacon slot.

11. The communications device of claim 10, further comprising:
means for reducing the backoff time at a predetermined rate during said first beacon slot during time when a signal which: exceeds a first power level threshold or is decodable by the communications device, is not being received; and
means for suspending reduction of said backoff time during receipt of a signal which exceeds the first power level threshold or is decodable by the communications device.

12. The communications device of claim 8, further comprising:
means for comparing a time indicated in a received beacon signal to a time indicated at the time of receipt of said received beacon signal by a clock of said communications device, if said monitoring detects receipt of a beacon signal;
means for updating the time indicated by the clock of the communications device to match the time indicated in the received beacon signal when said comparing indicates that the time indicated in the received beacon signal is greater than the time indicated by the clock of said communications device; and
means for canceling transmission of the first beacon signal if the power of the received beacon signal exceeds a second power level threshold.

13. The communications device of claim 8, further comprising:
means for determining if a majority of time stamps, received prior to said first beacon slot, included in received beacon signals indicated an earlier time than a time indicated by the clock of the communications device at the time of receipt of the beacon signals; and
wherein said means for determining a backoff time includes means for increasing a probability that a short backoff time will be determined as compared to the probability when it is not determined that the majority of time stamps included in received beacon signals indicated an earlier time than the time indicated by the clock of the communications device at the time of receipt of the beacon signals.

14. The communications device of claim 8, wherein said means for determining a backoff time includes means for increasing a probability that a short backoff time will be determined when said communications device transmitted a beacon signal in a beacon slot immediately preceding said first beacon slot.

15. A computer program product for use in a communications device, the computer program product comprising:
a non-transitory computer readable medium comprising:
code for causing at least one computer to determine a backoff time used in controlling transmission of a first beacon signal in a first beacon slot;
code for causing said at least one computer to monitor to detect receipt of a beacon signal during said backoff time; and
code for causing said at least one computer to perform one of: altering said determined backoff time or canceling transmission of the beacon signal, in response to said monitoring detecting receipt of a beacon signal.

16. A communications device comprising:
at least one processor configured to:
determine a backoff time used in controlling transmission of a first beacon signal in a first beacon slot;
monitor to detect receipt of a beacon signal during said backoff time; and
perform one of: altering said determined backoff time or canceling transmission of the beacon signal, in response to said monitoring detecting receipt of a beacon signal; and
memory coupled to said at least one processor.

17. The communications device of claim 16, wherein said at least one processor is configured to:
compare a time indicated in a received beacon signal to a time indicated at the time of receipt of said received beacon signal by a clock of said communications device, if said monitoring detects receipt of a beacon signal; and
set the backoff time to a reduced value, when said comparing indicates that the time indicated in the received beacon signal is less than the time indicated by the clock of said communications device.

18. The communications device of claim 17, wherein said at least one processor is further configured to:
transmit the first beacon signal if said backoff time expires during said first beacon slot; and
cancel transmission of said first beacon signal if said backoff time does not expire within said first beacon slot.

19. The communications device of claim 18, wherein said at least one processor is further configured to:
reduce the backoff time at a predetermined rate during said first beacon slot during time when a signal, which exceeds a first power level threshold or is decodable by the communications device, is not being received; and
suspend reduction of said backoff time during receipt of a signal which exceeds the first power level threshold or is decodable by the communications device.

20. The communications device of claim 16, wherein said at least one processor is further configured to:
compare a time indicated in a received beacon signal to a time indicated at the time of receipt of said received beacon signal by a clock of said communications device, if said monitoring detects receipt of a beacon signal;
update the time indicated by the clock of the communications device to match the time indicated in the received beacon signal when said comparing indicates that the time indicated in the received beacon signal is greater than the time indicated by the clock of said communications device; and
cancel transmission of the first beacon signal if the power of the received beacon signal exceeds a second power level threshold.
